(19) United States
(12) Patent Application Publication
(10) Pub. No.: US 2012/0024224 A1
(43) Pub. Date: Feb. 2, 2012

(54) RESIN COMPOSITION FOR LASER ENGRAVING, RELIEF PRINTING PLATE PRECURSOR FOR LASER ENGRAVING AND PROCESS FOR PRODUCING THE SAME, AND RELIEF PRINTING PLATE AND PROCESS FOR MAKING THE SAME

(75) Inventors: Shigefumi KANCHIKU, Haibara-gun (JP); Atsushi SUGASAKI, Haibara-gun (JP)

(73) Assignee: FUJIFILM CORPORATION, Tokyo (JP)

(21) Appl. No.: 13/185,815

(22) Filed: Jul. 19, 2011

(30) Foreign Application Priority Data
Jul. 27, 2010 (JP) 2010-168527

(51) Int. Cl. B05C 1/16; C08L 83/06; B29C 35/08; C08L 29/14; C08G 77/06; C08G 77/16; C08L 33/00

(52) U.S. Cl. 118/46; 528/27; 525/50; 525/101; 525/58; 264/400

(57) ABSTRACT

A resin composition for laser engraving, comprising (Component A) a compound having two or more ring structures selected from the group consisting of an epoxy ring, an oxetane ring and a five-membered carbonate ring, (Component B) a curing agent capable of reacting with Component A to thus form a crosslinked structure, and (Component C) a compound having at least one of a hydrolyzable silyl group and a silanol group.

### TECHNICAL FIELD

The present invention relates to a resin composition for laser engraving, relief printing plate precursor for laser engraving and a process for producing the same, and a relief printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

As the relief printing plate precursor for laser engraving, those described in JP-A-2010-100048 (JP-A denotes a Japanese unexamined patent application publication), JP-A-2009-262370 or International Patent Application WO 2005-070691 are known.

### SUMMARY OF THE INVENTION

### Problems to be Solved by the Invention

It is an object of the present invention to provide a resin composition for laser engraving that can give a relief printing plate having excellent film elasticity, printing durability and aqueous ink transfer properties, a relief printing plate precursor using the resin composition for laser engraving, a process for making a relief printing plate using the same, and a relief printing plate obtained thereby.

The above-mentioned object of the present invention has been achieved by means described in <1>, <12>, <13>, <15>, <17>, or <19> below. They are described below together with <2> to <11>, <14>, <16>, <18>, <20>, and <21> which are preferred embodiments.

<1> A resin composition for laser engraving, comprising (Component A) a compound having two or more ring structures selected from the group consisting of an epoxy ring, an oxetane ring and a five-membered carbonate ring, (Component B) a curing agent capable of reacting with Component A to thus form a crosslinked structure, and (Component C) a compound having at least one of a hydrolyzable silyl group and a silanol group,
<2> the resin composition for laser engraving according to <1> above, wherein Component B is a compound having one or more functional groups selected from the group consisting of a primary amino group and an acid anhydride group, or a compound having two or more functional groups selected from the group consisting of a secondary amino group, a mercapto group, a carboxyl group, a phenolic hydroxyl group and a hydroxyl group,
<3> the resin composition for laser engraving according to <1> or <2> above, wherein Component C is a compound having a total of two or more hydrolyzable silyl groups and silanol groups,
<4> the resin composition for laser engraving according to any one of <1> to <3> above, wherein the hydrolyzable silyl group in Component C is a hydrolyzable silyl group having at least one of an alkoxy group and a halogen atom bonded to a Si atom,
<5> the resin composition for laser engraving according to any one of <1> to <4> above, wherein Component A is a compound having two or more epoxy rings,
<6> the resin composition for laser engraving according to any one of <1> to <5> above, wherein the composition further comprises (Component D) a curing accelerator,
<7> the resin composition for laser engraving according to any one of <1> to <6> above, wherein the composition further comprises (Component E) a binder polymer,
<8> the resin composition for laser engraving according to <7> above, wherein the glass transition temperature (Tg) of Component E is at least 20° C. but less than 200° C.,
<9> the resin composition for laser engraving according to <7> or <8> above, wherein Component E is one or more resins selected from the group consisting of an acrylic resin, polyvinyl butyral and derivatives thereof,
<10> the resin composition for laser engraving according to any one of <1> to
<9> above, wherein the composition further comprises (Component F) a photothermal conversion agent capable of absorbing light having a wavelength of 700 to 1,300 nm,
<11> the resin composition for laser engraving according to any one of <1> to <10> above, wherein the composition further comprises (Component G) a catalyst for an alcohol exchange reaction,
<12> a relief printing plate precursor for laser engraving, comprising a relief-forming layer comprising the resin composition for laser engraving according to any one of <1> to <11> above over a support,
<13> a relief printing plate precursor for laser engraving, comprising a crosslinked relief-forming layer formed by crosslinking the relief-forming layer comprising the resin composition for laser engraving according to any one of <1> to <11> above by light and/or heat over a support,
<14> the relief printing plate precursor for laser engraving according to <13> above, wherein the crosslinked relief-forming layer is a crosslinked relief-forming layer crosslinked by heat,
<15> a process for producing a relief printing plate precursor for laser engraving, comprising a layer forming step of a relief-forming layer comprising the resin composition for laser engraving according to any one of <1> to <11> above, and a crosslinking step of crosslinking the relief-forming layer by light and/or heat to thus obtain a relief printing plate precursor having a crosslinked relief-forming layer,
<16> a process for producing the relief printing plate precursor for laser engraving according to <15> above, wherein the crosslinking step is a step of crosslinking the relief-forming layer by heat to thus obtain a relief printing plate precursor having a crosslinked relief-forming layer,
<17> a process for making a relief printing plate, comprising a layer forming step of a relief-forming layer comprising the resin composition for laser engraving according to any one of <1> to <11> above, a crosslinking step of crosslinking the relief-forming layer by light and/or heat to thus obtain a relief printing plate precursor having a crosslinked relief-forming layer, and an engraving step of laser engraving the relief printing plate precursor having the crosslinked relief-forming layer to thus form a relief layer,
<18> the process for making the relief printing plate according to <17> above, wherein the crosslinking step is a step of crosslinking the relief-forming layer by heat to thus obtain a relief printing plate precursor having a crosslinked relief-forming layer,
<19> a relief printing plate having a relief layer manufactured by the process for making a printing plate according to <17> or <18> above,
<20> the relief printing plate according to <19> above, wherein the thickness of the relief layer is at least 0.05 mm but no greater than 10 mm,
<21> the relief printing plate according to <19> or <20> above, wherein the Shore A hardness of the relief layer is at least 50° but no greater than 90°.

### Mode for Carrying Out the Invention

The present invention is explained in detail below.

### (Resin Composition for Laser Engraving)

The resin composition for laser engraving of the present invention (hereinafter, also simply called “the resin composition”) comprises (Component A) a compound having two or more ring structures selected from the group consisting of an epoxy ring, an oxetane ring and five-membered carbonate ring, (Component B) a curing agent capable of reacting with Component A to thus form a crosslinked structure, and (Component C) a compound having at least one of a hydrolyzable silyl group and a silanol group.

Meanwhile, in the present invention, the description of “from the lower limit to the upper limit” showing the range of numerical values shows “from not less than the lower limit to not more than the upper limit,” and the description of “from the upper limit to the lower limit” shows “from not more than the upper limit to not less than the lower limit.” That is, the description shows the range of numerical values including the upper limit and the lower limit. Moreover, “the resin composition” in the present invention includes not only compositions containing a resin but also compositions containing a compound capable of forming a resin.

In addition to the application to the relief-forming layer of the relief printing plate precursor, to which the laser engraving is to be given, the resin composition for laser engraving of the present invention can be widely applied to other applications without particular limitations. For example, the composition can be applied not only to the relief-forming layer of a printing plate precursor in which a convex relief is formed by laser engraving to be described in detail below, but also to other material in which asperities or apertures are formed on the surface, for example, to the formation of various printing plates and various formed bodies in which images are formed by laser engraving such as an intaglio plate, a stencil plate, and a stamp.

Of these, the application to the relief-forming layer disposed over an appropriate support is a preferable embodiment.

The action mechanism in the use of Component A, Component B and Component C in combination in the resin composition of the present invention is explained, for example, a silane coupling agent, which is described later, and a reaction product obtained by the reaction of Component A with Component B. Although the action mechanism thereof is not certain, it is presumed as follows.

It is presumed that the reaction of Component A with Component B causes the ring-opening of the epoxy ring, the oxetane ring or the five-membered carbonate ring in Component A to generate a hydroxyl group.

In the resin composition, a silane coupling group (a hydrolyzable silyl group and/or a silanol group) of (C-1) a silane coupling agent brings about the alcohol exchange reaction with a hydroxyl group (—OH) of the reaction product of coexisting Component A and Component B, and, as the result, molecules of the reaction product of Component A and Component B are three-dimensionally crosslinked each other by the silane coupling agent. As a result, there are (I) an effect of improving rinsing properties due to engraving residue formed by laser engraving turning from a liquid state into a powder state and becoming removable not only when washed with an alkaline washing liquid but also when merely rinsed with tap water and (II) an effect of resistance to plastic deformation due to improved breaking strength and elasticity of the film when formed using the resin composition. The effect (II) of improved breaking strength and elasticity of the film also brings about an effect of improving ink transfer properties and printing durability of a printing plate formed when the resin composition of the present invention has application as a relief-forming layer. In a preferable embodiment of the present invention, the existence of a hetero atom in a linking group linking silane coupling groups each other in the silane coupling agent can give, too, (III) an effect of improvement of the engraving sensitivity caused by the hetero atom and the effect of the sensitivity improvement is significant when a S atom is contained as the hetero atom.

With regard to (I) the improvement effect of rinsing properties, it is considered that the crosslinking of the binders each other with the silane coupling agent has enlarged the molecular weight of the polymer compound itself constituting the film that comprises the resin composition before the engraving, and that the residue generated in the laser engraving becomes a residue formed into powder in which the stickiness due to a low molecular weight liquid component is suppressed to give rinsing properties of being removed easily with tap water. Moreover, it is considered that the reaction products of Component A and Component B are directly crosslinked each other via (C-1) a silane coupling agent to form a three-dimensionally crosslinked structure in the molecule to satisfy the condition of expressing rubber elasticity to thus show apparent behaviors like rubber, and that, as the result, the effect (II) of improving film elasticity can be obtained. Accordingly, it is presumed that, when the resin composition of the present invention is formed into a film to produce the relief-forming layer, the relief layer obtained thereby has an improved film elasticity, and that, even in a state where printing pressure is applied repeatedly in printing over a long period, plastic deformation is suppressed to realize excellent ink transfer properties and to better the printing durability, too.

Moreover, when (C-1) a silane coupling agent has a linking group having a heteroatom bonding to a carbon in the molecule, the carbon atom adjacent to the heteroatom is in an electronic state in which covalent electrons are biased toward the heteroatom and is energetically easily cleaved. It is thought that, as a result, it is easily thermally decomposed by laser engraving and (III) engraving sensitivity improves.

As described above, in the resin composition of the present invention comprising (C-1) a silane coupling agent, and the reaction product resulted from the reaction of Component A with Component B, (C-1) a silane coupling agent and the hydroxyl group in the reaction product resulted from the reaction of Component A with Component B react to form the crosslinked structure in the preparation and film formation of the composition, and thus the composition expresses various excellent physical properties. The effect results from the reaction of functional groups each other that lie in each of Component C, and the reaction product resulted from the reaction of Component A with Component B, and that have interactive properties. Here, the silane coupling group and the hydroxyl group are exemplified, but other functional groups also show similar action mechanism.

It is possible to confirm the formation of the crosslinked structure resulted from the progress of the reaction of (C-1) a silane coupling agent with the reaction product resulted from the reaction of Component A and Component B in the resin composition of the present invention by a method below.

It may be identified for the crosslinked film using “solid state ¹³C-NMR.”

The electronic circumstance of a carbon atom directly bonded to an OH group in the reaction product resulted from the reaction of Component A with Component B changes before and after the reaction with (C-1) a silane coupling agent, and, along with this, the peak position shifts. The actual progress of the alcohol exchange reaction and an approximate reaction ratio can be known by comparing respective peak intensities derived from the carbon atom directly bonded to an unreacted OH group and derived from the carbon atom formed into an alkoxy group after the reaction with (C-1), before and after the crosslinking. The degree of the shift of the peak position differs depending on the structure of the reaction product used resulted from the reaction of Component A with Component B, and the change is a relative index.

As another method, in addition, a method may be denoted, in which films before and after the crosslinking are immersed in a solvent and the change in the appearance of films is observed visually. The progress of the crosslinking may also be known by the method.

Specifically, the resin composition is formed into a film, which is immersed in acetone at room temperature (25° C.) for 24 hr, and the appearance is observed visually. When the crosslinked structure is not formed, or the crosslinked structure is formed slightly, the film dissolves in the acetone and deforms to such degree that the appearance can not be distinguished, or dissolves to give a state in which the solid material can not be observed visually. But, when it has the crosslinked structure, the film is insolubilized and has a state in which the appearance before the acetone immersion is left undisturbed.

In the specification, with regard to the explanation of the relief printing plate precursor, the relief-forming layer means a crosslinkable layer comprising Component A to Component C, having a flat surface as an image-forming layer to be offered for the laser engraving and having been not crosslinked, the crosslinked relief-forming layer means a layer obtained by crosslinking the relief-forming layer, and the relief layer means a layer in which concave and convex portions have been formed on the surface by the laser engraving.

Constituent components of the resin composition for laser engraving are explained below.

(Component A) A Compound Having Two or More Ring Structures Selected from the Group Consisting of an Epoxy Ring, an Oxetane Ring and a Five-Membered Carbonate Ring

The resin composition for laser engraving of the present invention comprises (Component A) a compound having two or more ring structures selected from the group consisting of an epoxy ring, an oxetane ring and a five-membered carbonate ring.

Component A may have any shape of monomer, oligomer and polymer, and, except for having two or more ring structures selected from the group consisting of an epoxy ring, an oxetane ring and a five-membered carbonate ring, the molecular weight and molecular structure are not particularly limited.

Component A is preferably a compound having a molecular weight of less than 1,000.

Component A is preferably a compound having two or more epoxy rings from the viewpoint of printing durability, and is preferably a compound having two or more ring structures selected from the group consisting of an oxetane ring and a five-membered carbonate ring from the viewpoint of aqueous ink durability.

Component A is preferably a compound not having an acid group, a hydroxyl group, an amide group or an amino group.

Component A may be used singly or in combination of two or more compounds.

Examples of the epoxy compounds having two or more epoxy rings that can be used in the invention include polyfunctional aliphatic epoxides, polyfunctional aromatic epoxides and polyfunctional alicyclic epoxides.

Examples of the aromatic epoxide include di- or polyglycidyl ethers produced by a reaction between epichlorohydrin and a polyhydric phenol having at least one aromatic nucleus or an alkylene oxide adduct thereof. Specific examples include di- or polyglycidyl ethers of bisphenol A or an alkylene oxide adduct thereof, di- or polyglycidyl ethers of hydrogenated bisphenol A or an alkylene oxide adduct thereof, and novolac type epoxy resins. Examples of the alkylene oxide above include ethylene oxide and propylene oxide.

Examples of the alicyclic epoxides include two or more cyclohexene oxides- and cyclopentene oxides-containing compounds obtained by epoxidizing a compound having at least two cycloalkene rings such as a cyclohexene ring or a cyclopentene ring with an appropriate oxidizing agent such as hydrogen peroxide or a peracid.

Examples of the aliphatic epoxides include di- or polyglycidyl ethers of an aliphatic polyhydric alcohol or an alkylene oxide adduct thereof. Representative examples thereof include diglycidyl ethers of an alkylene glycol such as the diglycidyl ether of ethylene glycol, the diglycidyl ether of propylene glycol, and the diglycidyl ether of 1,6-hexanediol, polyglycidyl ethers of a polyhydric alcohol such as the di- or triglycidyl ether of glycerol or an alkylene oxide adduct thereof, and diglycidyl ethers of a polyalkylene glycol such as the diglycidyl ether of polyethylene glycol or an alkylene oxide adduct thereof and the diglycidyl ether of polypropylene glycol or an alkylene oxide adduct thereof. Examples of the alkylene oxide above include ethylene oxide and propylene oxide.

Furthermore, examples of polyfunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexenylmethyl-3′,4′-epoxycyclohexenecarboxylate, 2-(3,4-epoxycyclohexyl-5,5-spiro-3,4-epoxy)cyclohexane-meta-dioxane, bis(3,4-epoxycyclohexylmethyl) adipate, vinylcyclohexene dioxide, 4-vinylepoxycyclohexane, bis(3,4-epoxy-6-methylcyclohexylmethyl) adipate, 3,4-epoxy-6-methylcyclohexenyl 3′,4′-epoxy-6′-methylcyclohexenecarboxylate, methylenebis(3,4-epoxycyclohexane), dicyclopentadiene diepoxide, the di(3,4-epoxycyclohexylmethyl)ether of ethylene glycol, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,13-tetradecadiene dioxide, limonene dioxide, 1,2,7,8-diepoxyoctane, and 1,2,5,6-diepoxycyclooctane.

Examples of the epoxy polymers having two or more epoxy rings that can be used in the invention include crystalline epoxy resins such as a biphenyl type epoxy resin, a bisphenol F type epoxy resin, a bisphenol F type epoxy resin, and a stilbene type epoxy resin; novolak epoxy resins such as a phenolic novolak type epoxy resin, a cresolic novolak type epoxy resin, and a naphtholic novolak type epoxy resin; polyfunctional epoxy resins such as a triphenolmethane type epoxy resin, and an alkyl-modified triphenolmethane type epoxy resin; aralkyl type resins such as a phenolic aralkyl type epoxy resin having a phenylene skeleton, a phenolic aralkyl type epoxy resin having a biphenylene skeleton, a naphtholic aralkyl type epoxy resin having a phenylene skeleton, a naphtholic aralkyl type epoxy resin having a biphenylene skeleton, and a naphtholic aralkyl type epoxy resin; naphthol type epoxy resins such as a dihydroxynaphthalene type epoxy resin, and a epoxy resin obtained by glycidyletherification a dimmer of a hydroxynaphthalene and/or a dihydroxynaphthalene; triazine core-containing epoxy resins such as triglycidyl isocyanurate, and monoallyl diglycidyl isocyanurate; bridged cyclic hydrocarbon compound-modified phenol type epoxy resins such as a dicyclopentadiene-modified phenol type epoxy resin; sulfur atom-containing type epoxy resins such as a bisphenol S type epoxy resin.

A compound having two or more oxetane rings that can be used in the invention is not particularly limited, and examples of the compounds thereof include the compounds listed below.

Examples of compounds having two oxetane rings that can be used in the invention include compounds represented by Formula (Ox-1) or Formula (Ox-2) below.

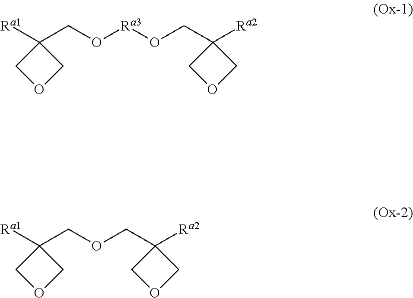

R^{a1} and R^{a2} independently denote a hydrogen atom, an alkyl group having 1 to 6 carbons, a fluoroalkyl group having 1 to 6 carbons, an allyl group, an aryl group, a furyl group, or a thienyl group.

Examples of the alkyl group include a methyl group, an ethyl group, a propyl group, and a butyl group, and preferred examples of the fluoroalkyl group include those obtained by substituting any of the hydrogen atoms of the above alkyl groups with a fluorine atom.

R^{a3} denotes a linear or branched alkylene group, a linear or branched poly(alkyleneoxy) group, a linear or branched unsaturated hydrocarbon group, a carbonyl group, a carbonyl group-containing alkylene group, a carboxyl group-containing alkylene group, a carbamoyl group-containing alkylene group, or a group shown below. Examples of the alkylene group include an ethylene group, a propylene group, and a butylene group, and examples of the poly(alkyleneoxy) group include a poly(ethyleneoxy) group and a poly(propyleneoxy) group. Examples of the unsaturated hydrocarbon group include a propenylene group, a methylpropenylene group, and a butenylene group.

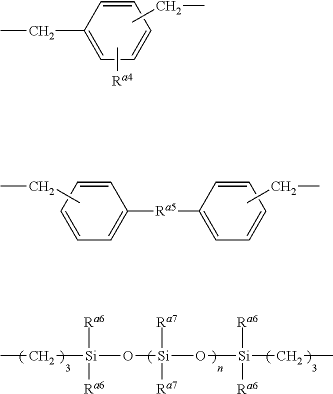

When R^{a3} is the above-mentioned polyvalent group, R^{a4} denotes a hydrogen atom, an alkyl group having 1 to 4 carbons, an alkoxy group having 1 to 4 carbons, a halogen atom, a nitro group, a cyano group, a mercapto group, a lower alkylcarboxyl group, a carboxyl group, or a carbamoyl group.

R^{a5} denotes an oxygen atom, a sulfur atom, a methylene group, NH, SO, SO₂, C(CF₃)₂, or, C(CH₃)₂.

R^{a6} denotes an alkyl group having 1 to 4 carbons or an aryl group, and n is an integer of 0 to 2,000. R^{a7} denotes an alkyl group having 1 to 4 carbons, an aryl group, or a monovalent group having the structure below. In the formula, R^{a8} denotes an alkyl group having 1 to 4 carbons or an aryl group, and m is an integer of 0 to 100.

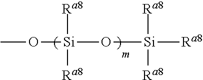

Preferable examples of the compound represented by Formula (Ox-1) include 1,4-bis[(3-ethyl-3-oxetanylmethoxy)methyl]benzene (OXT-121: manufactured by Toagosei Co., Ltd.). Preferable examples of the compound represented by Formula (Ox-2) include bis(3-ethyl-3-oxetanylmethyl)ether (OXT-221: manufactured by Toagosei Co., Ltd.).

Examples of the compound having 3 to 4 oxetane rings in the molecule include compounds represented by Formula (Ox-3) below.

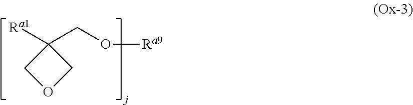

In Formula (Ox-3), R^{a1} denotes the same as in Formulae (Ox-1) and (Ox-2) above. Furthermore, examples of R^{ag}, which is a polyvalent linking group, include a branched alkylene group having 1 to 12 carbons such as a group represented by A to C below, a branched poly(alkyleneoxy) group such as a group represented by D below, and a branched polysiloxane group such as a group represented by E below. j is 3 or 4.

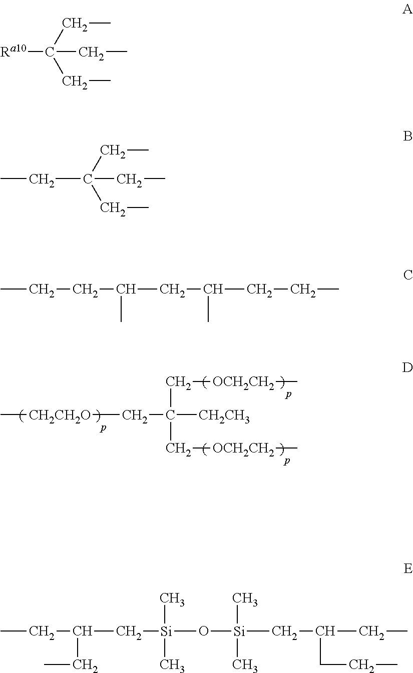

In the above A, R^{a10} denotes a methyl group, an ethyl group, or a propyl group. Furthermore, in the above D, p is an integer of 1 to 10.

Preferable examples of the compounds having two or more five-membered carbonate rings usable in the invention include a compound formed by converting epoxy rings in a compound having two or more epoxy rings into five-membered carbonate rings.

The compound having two or more five-membered carbonate rings can be synthesized, for example, using such reactions as a reaction of a corresponding diol with phosgene, a reaction of a corresponding oxirane with β-lactone, and a reaction of a corresponding oxirane with carbon dioxide.

Specific examples of the compounds having two or more five-membered carbonate rings include preferably compounds below.

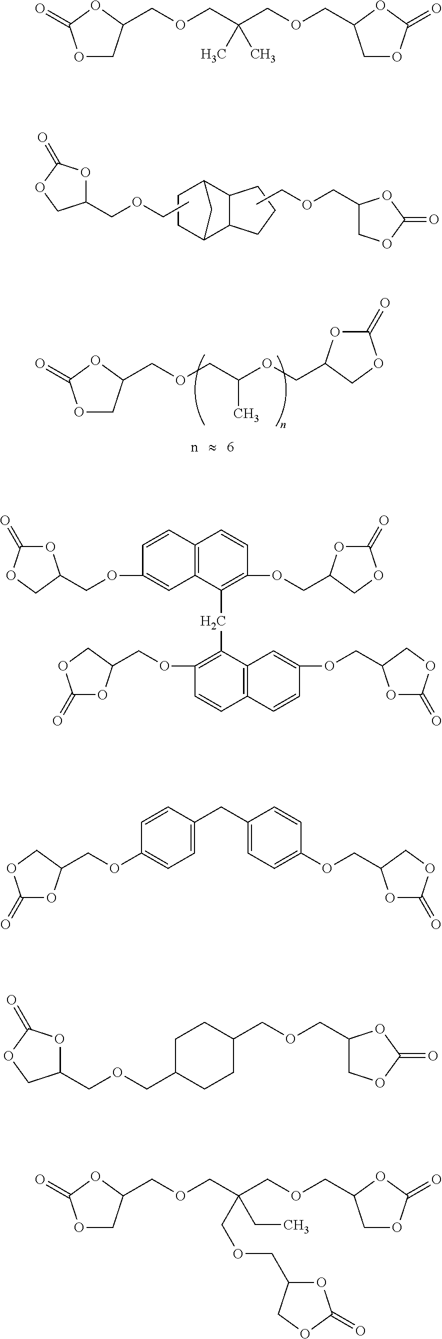

Preferable examples of Component A include compounds shown below, but the present invention is not limited to these compounds.

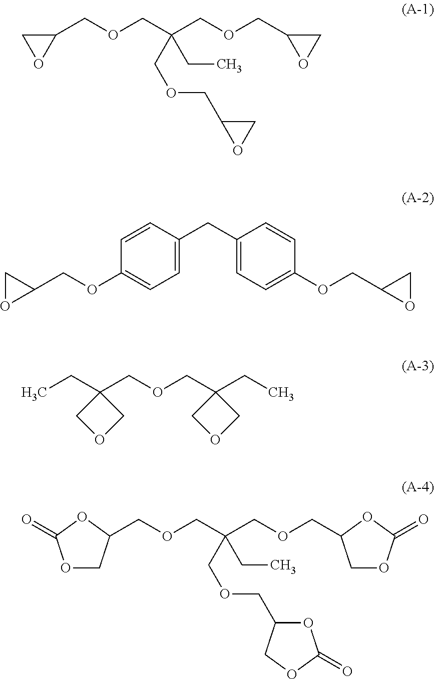

Relative to the total solids content, the content of Component A is preferably 0.05 to 60 wt %, more preferably 1 to 50 wt %, and yet more preferably 2 to 40 wt %.

(Component B) A Curing Agent Capable of Reacting with Component a to Thus Form a Crosslinked Structure

The resin composition for laser engraving of the present invention comprises (Component B) a curing agent capable of reacting with Component A to thus form a crosslinked structure.

Since the reaction proceeds rapidly and a film having high strength is obtained, Component B is preferably a compound having one or more functional groups selected from the group consisting of a primary amino group and an acid anhydride group, or a compound having two or more functional groups selected from the group consisting of a secondary amino group, a mercapto group, a carboxyl group, a phenolic hydroxyl group and a hydroxyl group, more preferably a compound having one or more functional groups selected from the group consisting of a primary amino group and an acid anhydride group, or a compound having two or more functional groups selected from the group consisting of a secondary amino group and a mercapto group, and yet more preferably a compound having one or more functional groups selected from the group consisting of a primary amino group and an acid anhydride group.

Component B may be singly or in combination of two or more compounds.

The compound having at least one primary amino group is not particularly limited, and various types thereof may be used.

Examples thereof include primary alkylamines such as butylamine, octylamine, oleylamine and 2-ethylhexylamine, primary anilines such as aniline, 4-aminoacetophenone, p-anisidine, 2-aminoanthracene and 1-naphthylamine, primary alkanolamines such as monoethanolamine, 2-ethoxyethanolamine and 2-hydroxypropanolamine, aliphatic polyamines such as hexanediamine, ethylenediamine, diethylenetriamine, triethylenetetramine, tetraethylenepentamine, m-xylenediamine and p-xylenediamine, alicyclic polyamines such as 1,3-diaminocyclohexane and isoholondiamine, polyanilines such as 1,4-phenylenediamine, 2,3-diaminonaphthalene, 2,6-diaminoanthraquinone, 2,2-bis(4-aminophenyl)hexafluoropropane, 4,4′-diaminobenzophenone and 4,4′-diaminodiphenylmethane, Mannich bases consisting of a polycondensate of polyamines, an aldehyde compound, mono- or polyvalent phenols, and polyamidopolyamines obtained by the reaction of polyamines with polycarboxylic acid or dimer acid.

Among these, because of the suitability for forming a high degree of three dimensional crosslinking, aliphatic polyamines, alicyclic polyamines and polyanilines are preferable, and, in particular, hexanediamine, triethylenetetramine, m-xylenediamine and 4,4′-diaminodiphenylmethane are more preferable.

The compound having at least two secondary amino groups is not particularly limited, and various types thereof may be used.

Examples thereof include N,N′-dimethylethylenediamine, N,N′-diethylethylenediamine, N,N′-dibenzylethylenediamine, N,N′-diisopropylethylenediamine, 2,5-dimethylpiperazine, N,N′-dimethylcyclohexane-1,2-diamine, piperazine, homopiperazine, 2-methylpiperazine, etc.

The compound having at least one acid anhydride group is not particularly limited, and various types thereof may be used.

Usable examples thereof include acid anhydride compounds such as succinic anhydride, maleic anhydride, phthalic anhydride, hexahydrophthalic anhydride, methylhexahydrophthalic anhydride, nadic anhydride, hydrogenated nadic anhydride, trimellitic anhydride, and pyromellitic anhydride. Among these, the use of methylhexahydrophthalic anhydride is particularly preferable, which gives a cured film that shows a little curing contraction and has transparency and high strength.

The compound having at least two mercapto groups is not particularly limited, and various types thereof may be used.

Examples thereof include alkanedithiols such as 1,2-ethanedithiol, 1,3-propanedithiol, 1,4-butanedithiol, 1,5-pentanedithiol, 1,6-hexanedithiol, 1,7-heptanedithiol, 1,8-octanedithiol, 1,9-nonanedithiol, 1,10-decanedithiol, 1,12-dodecanedithiol, 2,2-dimethyl-1,3-propanedithiol, 3-methyl-1,5-pentanedithiol and 2-methyl-1,8-octanedithiol, cycloalkanedithiols such as 1,4-cyclohexanedithiol, alkanedithiols containing a hetero atom in a carbon chain such as bis(2-mercaptoethyl)ether, bis(2-mercaptoethyl)sulfide, bis(2-mercaptoethyl)disulfide and 2,2′-(ethylenedithio)diethanethiol, alkanedithiols containing a hetero atom and an alicyclic structure in a carbon chain such as 2,5-bis(mercaptomethyl)-1,4-dioxane and 2,5-bis(mercaptomethyl)-1,4-dithiane, alkanetrithiols such as 1,1,1-tris(mercaptomethyl)ethane, 2-ether-2-mercaptomethyl-1,3-propanedithiol and 1,8-mercapto-4-mercaptomethyl-3,6-thiaoctane, alkanetetrathiols such as tetrakis(mercaptomethyl)methane, 3,3′-thiobis(propane-1,2-dithiol), 2,2′-thiobis(propane-1,3-dithiol), etc.

The compound having at least two carboxyl groups is not particularly limited, and various types thereof may be used.

Examples thereof include succinic acid, maleic acid, phthalic acid, hexahydrophthalic acid, methylhexahydrophthalic acid, nadic acid, hydrogenated nadic acid, trimellitic acid, pyromellitic acid, adipic acid, sebacic acid, dodecanedicarboxylic acid, isophthalic acid, 2-methylterephthalic acid, naphthalenedicarboxylic acid, etc.

The compound having at least two phenolic hydroxyl groups is not particularly limited, and various types thereof may be used.

Examples thereof include novolac type resins such as phenolnovolac resin, cresolnovolac resin and naphtholnovolac resin; polyfunctional type phenol resins such as triphenolmethane type resin; modified phenol resins such as dicyclopentanediene-modified phenol resin and terpene-modified phenol resin; aralkyl type resins such as phenolaralkyl resin having a phenylene skeleton, phenolaralkyl resin having a biphenylene skeleton, naphtholaralkyl resin having a phenylene skeleton and naphtholaralkyl resin having a biphenylene skeleton; bisphenol compounds such as bisphenol A and bisphenol F; a sulfur atom-containing type phenol resins such as bisphenol S, etc.

As the compound having at least two hydroxyl groups, various kinds may be used, without particular limitations.

Examples thereof include ethylene glycol, diethylene glycol, propylene glycol, dipropylene glycol, trimethylene glycol, 1,4-tetramethylenediol, 1,3-tetramethylenediol, 2-methyl-1,3-trymethylenediol, 1,5-pentamethylenediol, neopentyl glycol, 1,6-hexamethylenediol, 3-methyl-1,5-pentamethylenediol, 2,4-diethyl-1,5-pentamethylenediol, glycerin, trimethylolpropane, trimethylolethane, cyclohexanediols (such as 1,4-cyclohexanediol), bisphenols (such as bisphenol A), sugar alcohols (such as xylitol and sorbitol), polyalkylene glycols such as polyethylene glycol, polypropylene glycol and polytetramethylene glycol, etc.

Specific examples of preferable Component B include compounds shown below, but the present invention is not limited to these compounds.

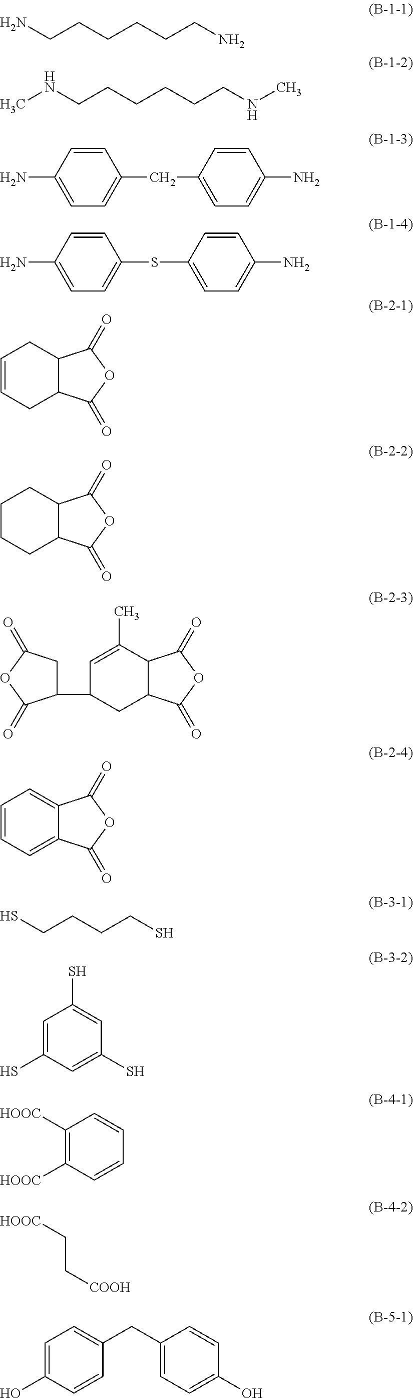

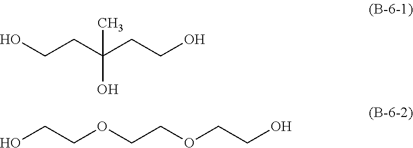

Relative to the total solids content of the resin composition, the content of Component B is preferably 0.05 to 40 wt %, more preferably 1 to 30 wt %, and yet more preferably 2 to 20 wt %.

Moreover, relative to the total solids content of the resin composition, the total content of Component A and Component B is preferably 0.1 to 80 wt %, more preferably 5 to 60 wt %, and most preferably 10 to 40 wt %.

Furthermore, the ratio of the total molar amount of the epoxy ring, the oxetane ring and the five-membered carbonate ring in Component A and the total molar amount of functional groups capable of reacting with Component A to thus form the crosslinked structure in Component B such as the primary amino group is preferably in the range of functional group of Component A/functional group of Component B=0.5 to 2.0, more preferably in the range of 0.7 to 1.5, and most preferably 0.8 to 1.2.

From the viewpoint of causing the effect of the present invention to be exerted more, as the combination of Component A and Component B, preferably Component A is a compound having two or more epoxy rings or oxetane rings and Component B is a compound having one or more functional groups selected from the group consisting of a primary amino group and an acid anhydride group, or a compound having two or more functional groups selected from the group consisting of a secondary amino group, a mercapto group, a carboxyl group, a phenolic hydroxyl group and a hydroxyl group, more preferably Component A is a compound having two or more epoxy rings and Component B is a compound having one or more functional groups selected from the group consisting of a primary amino group and an acid anhydride group, or a compound having two or more functional groups selected from the group consisting of a secondary amino group, a mercapto group, a carboxyl group, a phenolic hydroxyl group and a hydroxyl group, and particularly preferably Component A is a compound having two or more epoxy rings and Component B is a compound having one or more functional groups selected from the group consisting of a primary amino group and an acid anhydride group.

### (Component C) A Compound Having at Least One of a Hydrolyzable Silyl Group and a Silanol Group

The resin composition for laser engraving of the present invention comprises (Component C) a compound having at least one of a hydrolyzable silyl group and a silanol group.

The ‘hydrolyzable silyl group’ of Component C used in the resin composition for laser engraving of the present invention is a silyl group that is hydrolyzable; examples of hydrolyzable groups include an alkoxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or silanol group is preferably one represented by Formula (I) below.

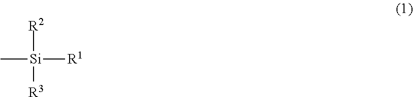

In Formula (I) above, R¹ to R³ denote independently a hydrolyzable group selected from the group consisting of an alkoxy group, an aryloxy group, a mercapto group, a halogen atom, an amide group, an acetoxy group, an amino group, and an isopropenoxy group, or a hydroxy group, a hydrogen atom, or a monovalent organic group. At least one of R¹ to R³ denotes a hydrolyzable group selected from the group consisting of an alkoxy group, an aryloxy group, a mercapto group, a halogen atom, an amide group, an acetoxy group, an amino group, and an isopropenoxy group, or a hydroxy group.

When R¹ to R³ denote a monovalent organic group, from the viewpoint that solubility in various types of organic solvents can be given, an organic group is preferably an alkyl group having 1 to 30 carbon atoms.

In Formula (I) above, the hydrolyzable group bonded to the silicon atom is particularly preferably an alkoxy group or a halogen atom.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms.

Furthermore, examples of the halogen atom include a F atom, a Cl atom, a Br atom, and a I atom, and from the viewpoint of ease of synthesis and stability it is preferably a Cl atom or a Br atom, and more preferably a Cl atom.

‘(Component C) a compound having at least one of a hydrolyzable silyl group and a silanol group’ in the present invention is preferably a compound having one or more groups represented by Formula (I) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in the compound is preferably at least 2 but no greater than 6, and most preferably 2 or 3.

A range of 1 to 3 of the hydrolyzable groups may bond to one silicon atom, and the total number of hydrolyzable groups in Formula (I) is preferably in a range of 2 or 3. It is particularly preferable that three hydrolyzable groups are bonded to a silicon atom. When two or more hydrolyzable groups are bonded to a silicon atom, they may be identical to or different from each other.

Examples of the alkoxy group include a methoxy group, an ethoxy group, a propoxy group, an isopropoxy group, a butoxy group, a tert-butoxy group, and a benzyloxy group. Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group. A plurality of each of these alkoxy groups may be used in combination, or a plurality of different alkoxy groups may be used in combination.

Examples of the aryloxy group include phenoxy group. Examples of the aryloxysilyl group having an aryloxy group bonded thereto include a triarylsilyl group such as a triphenylsilyl group.

As specific preferred examples of Component C in the present invention, there can be cited a compound in which a plurality of groups represented by Formula (I) above are bonded via a divalent linking group, and from the viewpoint of the effect, such a divalent linking group is preferably a linking group having a sulfide group, an imino group or a ureylene group.

A representative synthetic method for a Component C containing a linking group having a sulfide group, an imino group or a ureylene group is shown below.

<Synthetic Method for Compound Having Sulfide Group as Linking Group and Having Hydrolyzable Silyl Group and/or Silanol Group>

A synthetic method for a Component C having a sulfide group as a linking group (hereinafter, called as appropriate a ‘sulfide linking group-containing Component C’) is not particularly limited, but can be synthesized by one of a synthetic method selected from the group comprising reaction of a Component C having a halogenated hydrocarbon group with an alkali metal sulfide, reaction of a Component C having a mercapto group with a halogenated hydrocarbon, reaction of a Component C having a mercapto group with a Component C having a halogenated hydrocarbon group, reaction of a Component C having a halogenated hydrocarbon group with a mercaptan, reaction of a Component C having an ethylenically unsaturated double bond with a mercaptan, reaction of a Component C having an ethylenically unsaturated double bond with a Component C having a mercapto group, reaction of a compound having an ethylenically unsaturated double bond with a Component C having a mercapto group, reaction of a ketone with a Component C having a mercapto group, reaction of a diazonium salt with a Component C having a mercapto group, reaction of a Component C having a mercapto group with an oxirane, reaction of a Component C having a mercapto group with a Component C having an oxirane group, reaction of a mercaptan with a Component C having an oxirane group, and reaction of a Component C having a mercapto group with an aziridine.

<Synthetic Method for Compound Having Imino Group as Linking Group and Having Hydrolyzable Silyl Group and/or Silanol Group>

A synthetic method for a Component C having an imino group as a linking group (hereinafter, called as appropriate an ‘imino linking group-containing Component C’) is not particularly limited, but can be synthesized by one of a synthetic method selected from the group comprising reaction of a Component C having an amino group with a halogenated hydrocarbon, reaction of a Component C having an amino group with a Component C having a halogenated hydrocarbon group, reaction of a Component C having a halogenated hydrocarbon group with an amine, reaction of a Component C having an amino group with an oxirane, reaction of a Component C having an amino group with a Component C having an oxirane group, reaction of an amine with a Component C having an oxirane group, reaction of a Component C having an amino group with an aziridine, reaction of a Component C having an ethylenically unsaturated double bond with an amine, reaction of a Component C having an ethylenically unsaturated double bond with a Component C having an amino group, reaction of a compound having an ethylenically unsaturated double bond with a Component C having an amino group, reaction of a compound having an acetylenically unsaturated triple bond with a Component C having an amino group, reaction of a Component C having an imine-based unsaturated double bond with an organic alkali metal compound, reaction of a Component C having an imine-based unsaturated double bond with an organic alkaline earth metal compound, and reaction of a carbonyl compound with a Component C having an amino group.

<Synthetic Method for Compound Having Ureylene Group (Urea Bond) as Linking Group and Having Hydrolyzable Silyl Group and/or Silanol Group>

A synthetic method for Component C having an ureylene group (hereinafter, called as appropriate a ‘ureylene linking group-containing Component C’) as a linking group is not particularly limited, but can be synthesized by one of a synthetic method selected from the group comprising reaction of a Component C having an amino group with an isocyanate ester, reaction of a Component C having an amino group with a Component C having an isocyanate ester, and reaction of an amine with a Component C having an isocyanate ester.

As Component C in the present invention, the use of (C-1) a silane coupling agent is preferable.

(C-1) a silane coupling agent

(C-1) a silane coupling agent favorable as Component C in the present invention is explained below.

In the present invention, a functional group in which at least one alkoxy group or halogeno group (halogen atom) is directly bonded to a Si atom is called a silane coupling group, and a compound having one or more silane coupling groups in a molecule is called a silane coupling agent. Silane coupling groups having two or more alkoxy groups or halogen atoms directly bonded to a Si atom are preferable, and those having three or more of these directly bonded are particularly preferable.

In the resin composition of the present invention, at least one of the hydrolyzable silyl group and the silanol group in Component C, preferably the silane coupling group in (C-1) a silane coupling agent initiates the alcohol exchange reaction with the reactive functional group in the reaction product of Component A and Component B or the binder polymer, for example, when it is a hydroxyl group (—OH), with the hydroxyl group to thus form the crosslinked structure. As the result, molecules of the binder polymer are crosslinked each other three dimensionally via the silane coupling agent.

(C-1) a silane coupling agent, which is a preferable embodiment of Component C in the present invention, has indispensably at least one functional group of an alkoxy group and a halogen atom directly bonded to a Si atom as the functional group, and, from the viewpoint of easy handling of the compound, one having an alkoxy group is preferable.

Here, from the viewpoint of rinsing properties and printing durability, the alkoxy group has preferably 1 to 30 carbon atoms, more preferably 1 to 15 carbon atoms, and particularly preferably 1 to 5 carbon atoms.

The halogen atom includes a F atom, a Cl atom, a Br atom and an I atom, and, from the viewpoint of the easiness of synthesis and stability, a Cl atom and a Br atom are preferable, and a Cl atom is more preferable.

From the viewpoint of maintaining the good balance of the crosslinking level and softness of the film, the silane coupling agent in the present invention contains the silane coupling group preferably at least 1 but no greater than 10 in the molecule, more preferably at least 1 but no greater than 5, and particularly preferably at least 2 but no greater than 4.

When two or more silane coupling groups are contained, preferably the silane coupling groups are linked each other by a linking group. As the linking group, di- or more valent organic groups that may have such substituent as a hetero atom or a hydrocarbon are cited, and, from the viewpoint of a high engraving sensitivity, an embodiment containing a hetero atom (N, S, O) is preferable, and a linking group containing a S atom is particularly preferable.

From such viewpoint, as the silane coupling agent in the present invention, a compound, which has two silane coupling groups having a methoxy group or an ethoxy group, particularly a methoxy group bonded to a Si atom as an alkoxy group in the molecule and these silane coupling groups are bonded via an alkylene group containing a hetero atom (particularly preferably a S atom), is preferable. More specifically, one having a linking group containing a sulfide group is preferable.

Examples of another preferable embodiment of the linking group linking silane coupling groups each other include a linking group having an oxyalkylene group. As the result that the linking group contains an oxyalkylene group, the rinsing properties of engraving residue after the laser engraving is improved. As the oxyalkylene group, an oxyethylene group is preferable, and a polyoxyethylene chain formed by linking plural oxyethylene groups is more preferable. The total number of oxyethylene groups in the polyoxyethylene chain is preferably 2 to 50, more preferably 3 to 30, and particularly preferably 4 to 15.

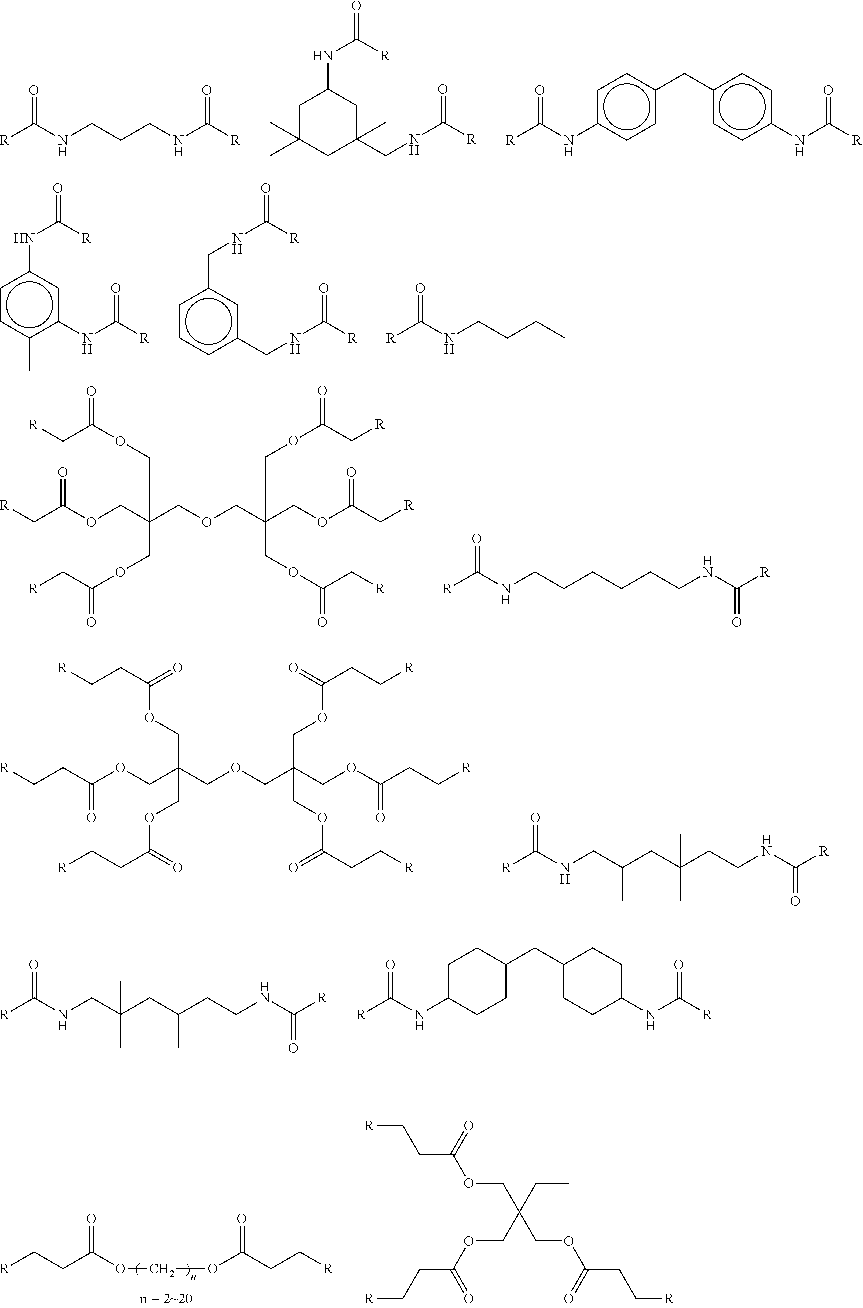

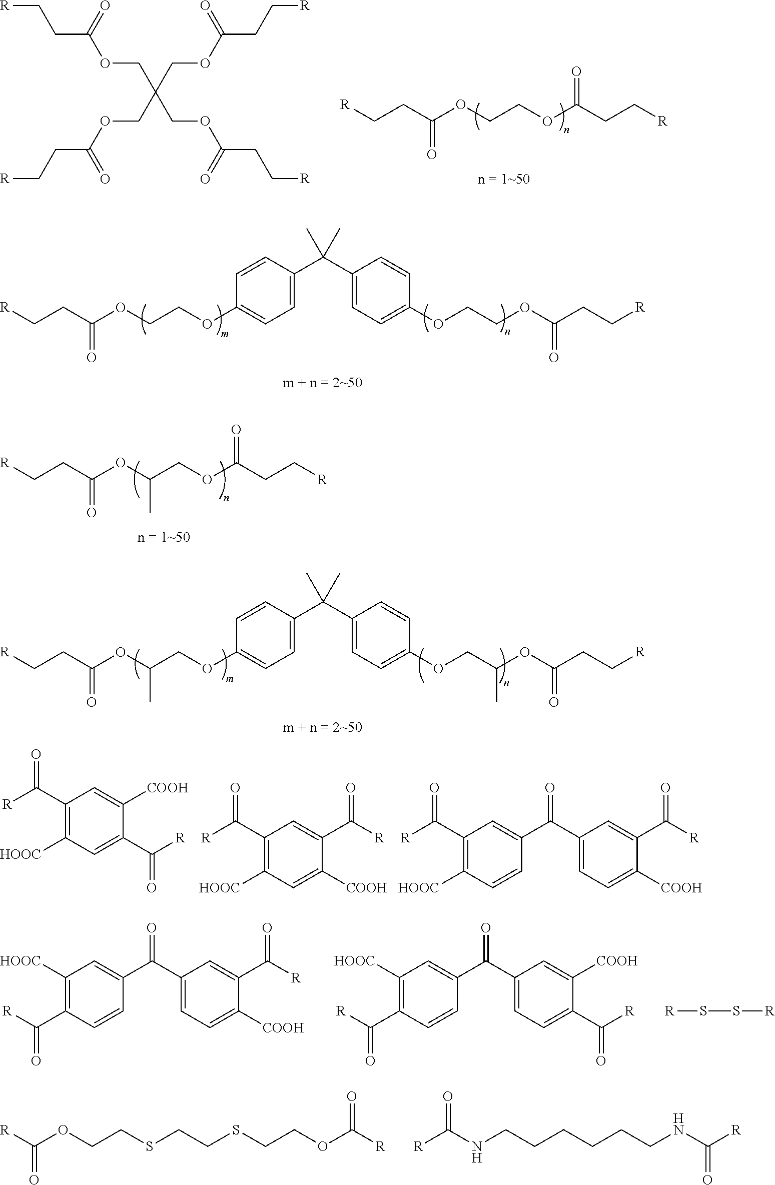

In each of the formulae above, R denotes a partial structure selected from the structures below. When a plurality of Rs and R¹s are present in the molecule, they may be identical to or different from each other, and are preferably identical to each other in terms of synthetic suitability. In the chemical structural formulae below, Et denotes an ethyl group and Me denotes a methyl group.

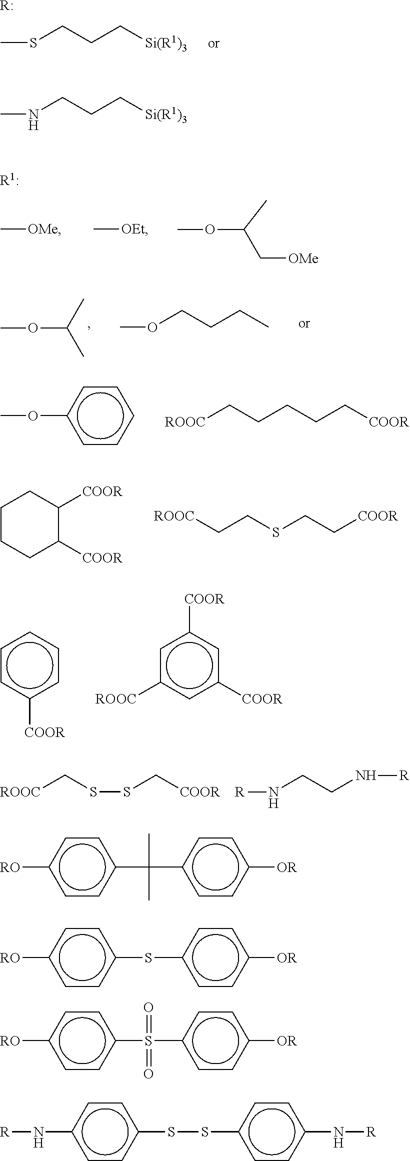

In each of the formulae above, R denotes a partial structure shown below. R¹ is the same as defined above. When a plurality of Rs and R¹s are present in the molecule, they may be identical to or different from each other, and in terms of synthetic suitability are preferably identical to each other.

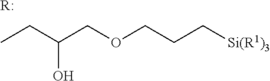

Component C may be obtained by synthesis as appropriate, but use of a commercially available product is preferable in terms of cost. Since Component C corresponds to for example commercially available silane products or silane coupling agents from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As a silane coupling agent in the present invention, other than the above-mentioned compounds, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Specific examples of such partial (co)hydrolysis condensates include a partial (co)hydrolysis condensate obtained by using, as a precursor, one or more selected from the group of silane compounds consisting of alkoxysilane or acetyloxysilane such as tetramethoxysilane, tetraethoxysilane, methyltrimethoxysilane, methyltriethoxysilane, methyltriisopropoxysilane, methyltriacetoxysilane, methyltris(methoxyethoxy)silane, methyltris(methoxypropoxy)silane, ethyltrimethoxysilane, propyltrimethoxysilane, butyltrimethoxysilane, hexyltrimethoxysilane, octyltrimethoxysilane, decyltrimethoxysilane, cyclohexyltrimethoxysilane, phenyltrimethoxysilane, phenyltriethoxysilane, tolyltrimethoxysilane, chloromethyltrimethoxysilane, γ-chloropropyltrimethoxysilane, 3,3,3-trifluoropropyltrimethoxysilane, cyanoethyltriethoxysilane, γ-glycidoxypropyltrimethoxysilane, γ-glycidoxypropyltriethoxysilane, β-(3,4-epoxycyclohexyl)ethyltrimethoxysilane, γ-aminopropyltrimethoxysilane, γ-aminopropyltriethoxysilane, N-β-(aminoethyl)-γ-aminopropyltrimethoxysilane, N-phenyl-γ-aminopropyltrimethoxysilane, γ-mercaptopropyltrimethoxysilane, dimethyldimethoxysilane, dimethyldiethoxysilane, diethyldimethoxysilane, methylethyldimethoxysilane, methylpropyldimethoxysilane, diphenyldimethoxysilane, diphenyldiethoxysilane, methylphenyldimethoxysilane, γ-chloropropylmethyldimethoxysilane, 3,3,3-trifluoropropylmethyldimethoxysilane, γ-glycidoxypropylmethyldiethoxysilane, γ-aminopropylmethyldiethoxysilane, N-β-(aminoethyl)-γ-aminopropylmethyldimethoxysilane and γ-mercaptopropylmethyldiethoxysilane, and acyloxysilane such as ethoxalyloxysilane.

Among these silane compounds as partial (co)hydrolysis-condensation product precursors, from the viewpoint of versatility, cost, and film compatibility, a silane compound having a substituent selected from a methyl group and a phenyl group as a substituent on the silicon is preferable, and specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is desirable to use a dimer (2 moles of silane compound is reacted with 1 mole of water to eliminate 2 moles of alcohol, thus giving a disiloxane unit) to 100-mer of the above-mentioned silane compound, preferably a dimer to 50-mer, and yet more preferably a dimer to 30-mer, and it is also possible to use a partial cohydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

Preferable examples of Component C include compounds shown below, but the present invention is not limited to these compounds. In the chemical structural formulae below, Et denotes an ethyl group and Me denotes a methyl group.

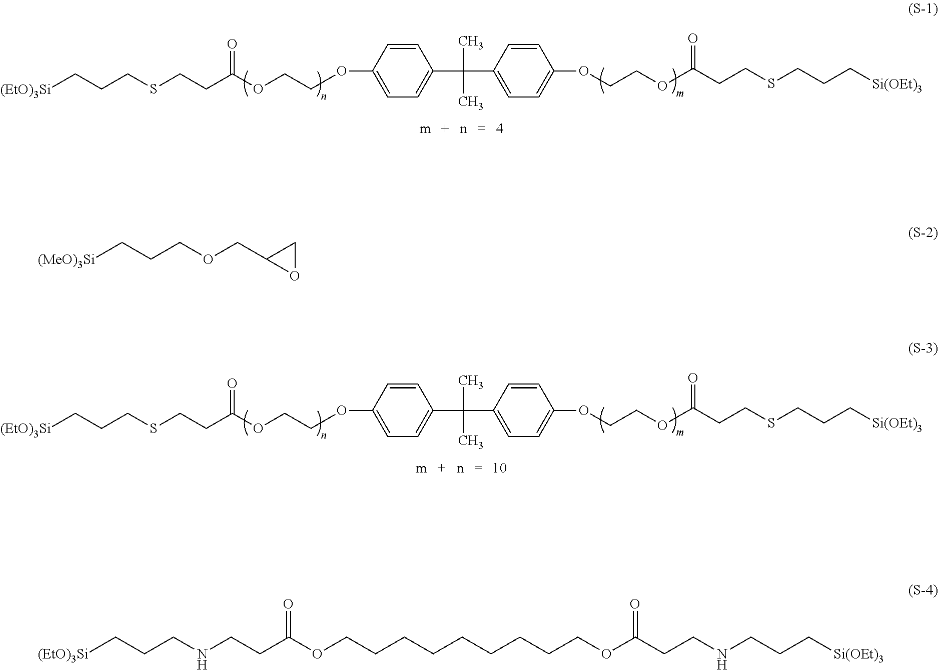

With regard to Component C in the resin composition of the present invention, only one type may be used or two or more types may be used in combination.

The content of Component C contained in the resin composition of the present invention is preferably in the range of 0.1 to 80 wt % on a solids content basis, more preferably in the range of 1 to 50 wt %, and most preferably in the range of 5 to 40 wt %.

### (Component D) A Curing Accelerator

The resin composition for laser engraving of the present invention preferably further comprises (Component D) a curing accelerator.

When a primary or secondary amino group is used as the curing agent, examples of the curing accelerators include phenols, alcohols, thiols, organic or inorganic acids, triphenylphosphine etc. Among these, acidic compounds form a salt with an amine compound to suppress the reaction of the amine compound with carbon dioxide or moisture in air. One having no reactivity with an epoxy group functions as a diluent, and the plasticizing effect thereof can retard the vitrification that leads to the termination of the curing reaction to thus improve the reaction ratio of the epoxy group.

When an acid anhydride group, a carboxyl group, a mercapto group, a phenol group or a hydroxyl group is used as the curing agent, examples of the curing accelerators include tertiary amines, imidazoles, quaternary ammonium salts, quaternary phosphonium salts, organic or inorganic acids, inorganic bases, triphenylphosphine etc.

As the curing accelerator, the compound is used as it is, or used in a state dissolved in a solvent such as water or an organic solvent. The concentration when it is dissolved in a solvent is not particularly limited, and may be selected appropriately in accordance with characteristics of the curing accelerator to be used, the intended content thereof etc.

When a curing agent having a primary or secondary amino group is used as Component B, as the curing accelerator, phenols, organic acids and thiols are preferable, and m-cresol and dodecanethiol are particularly preferable.

When a curing agent having an acid anhydride group is used as Component B, as the curing accelerator, a tertiary amine and salts thereof are preferable, and 1,8-diazabicyclo[5.4.0]undeca-7-ene (DBU) and salts thereof are particularly preferable.

When a curing agent having a mercapto group is used as Component B, as the curing accelerator, a tertiary amine and salts thereof are preferable, and DBU and salts thereof are particularly preferable.

When a curing agent having a carboxyl group is used as Component B, as the curing accelerator, quaternary ammonium salts and organic or inorganic acids are preferable, and tetraethylammonium bromide and p-toluenesulfonic acid are particularly preferable.

When a curing agent having a phenolic hydroxyl group is used as Component B, as the curing accelerator, quaternary ammonium salts, quaternary phosphonium salts and triphenylphosphine are preferable, and triphenylphosphine is particularly preferable.

When a curing agent having a hydroxyl group is used as Component B, as the curing accelerator, inorganic bases, and organic or inorganic acids are preferable, and sodium t-butoxide, potassium t-butoxide, sodium ethoxide and potassium ethoxide are particularly preferable.

As the curing accelerator usable in the resin composition for laser engraving of the present invention, types thereof are not particularly limited, and examples thereof include compounds shown below.

Examples of the phenols include phenol, o-cresol, m-cresol, p-cresol, o-chlorophenol, m-chlorophenol, p-chlorophenol, p-nitrophenol, 2,4-dinitrophenol, 2,4-dichlorophenol, o-aminophenol, p-aminophenol, 2,4,5-trichlorophenol etc. Among these, m-cresol, o-chlorophenol, m-chlorophenol, p-chlorophenol, p-nitrophenol, 2,4-dinitrophenol, 2,4-dichlorophenol and 2,4,5-trichlorophenol are preferable, and, furthermore among these, m-cresol that is easy to handle is more preferable.

Examples of the alcohols include methanol, ethanol, propanol, isopropanol, n-butylalcohol, isobutylalcohol, ethylene glycol, 1,3-propanediol, glycerin, propylene glycol, benzyl alcohol, diethylene glycol etc. Among these, benzyl alcohol, ethylene glycol, diethylene glycol and glycerin are preferable, and, furthermore among these, diethylene glycol is more preferable from the viewpoint of softness of the film.

Examples of the thiols include thiophenol, 1-butanethiol, 2-mercaptoethanol, thioglycerol, dodecanethiol, 2-aminoethanethiol, 1,4-butanethiol, 2,3-butanedithiol, 1,4-butanediolbis(thioglycolate), cyclopentanethiol, cyclohexanethiol etc. Among these, thiophenol, dodecanethiol, 1,4-butanediolbis(thioglycolate) are preferable, and, furthermore among these, dodecanethiol that is easy to handle is more preferable.

Examples of the organic or inorganic acids include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, heteropoly acid, inorganic solid acid etc. Among these, methanesulfonic acid, p-toluenesulfonic acid, pyridinium-p-toluene sulfonate, dodecylbenzenesulfonic acid, phosphoric acid, phosphonic acid and acetic acid are preferable, and, from the viewpoint of the film strength after the thermal crosslinking, methanesulfonic acid, p-toluenesulfonic acid and phosphoric acid are particularly preferable.

Examples of the tertiary amines and imidazoles include trimethylamine, triethylamine, tripropylamines, tributylamines, tripentylamines, trihexylamines, dimethylethylamine, dimethylpropylamines, dimethylbutylamines, dimethylpentylamines, dimethylhexylamines, diethylpropylamines, diethylbutylamines, diethylpentylamines, diethylhexylamines, dipropylbutylamines, dipropylpentylamines, dipropylhexylamines, dibutylpentylamines, dibutylhexylamines, dipentylhexylamines, methyldiethylamine, methyldipropylamines, methyldibutylamines, methyldipentylamines, methyldihexylamines, ethyldipropylamines, ethyldibutylamines, ethyldipentylamines, ethyldihexylamines, propyldibutylamines, propyldipentylamines, propyldihexylamines, butyldipentylamines, butyldihexylamines, pentyldihexylamines, methylethylpropylamines, methylethylbutylamines, methylethylhexylamines, methylpropylbutylamines, methylpropylhexylamines, ethylpropylbutylamine, ethylbutylpentylamines, ethylbutylhexylamines, propylbutylpentylamines, propylbutylhexylamines, butylpentylhexylamines, trivinylamine, triallylamine, tributenylamines, tripentenylamines, trihexenylamines, dimethylvinylamine, dimethylallylamine, dimethylbutenylamines, dimethylpentenylamines, diethylvinylamine, diethylallylamine, diethylbutenylamines, diethylpentenylamines, diethylhexenylamines, dipropylvinylamines, dipropylallylamines, dipropylbutenylamines, methyldivinylamine, methyldiallylamine, methyldibutenylamines, ethyldivinylamine, ethyldiallylamine, tricyclopentylamine, tricyclohexylamine, tricyclooctylamine, tricyclopentenylamine, tricyclohexenylamine, tricyclopentadienylamine, tricyclohexadienylamines, dimethylcyclopentylamine, diethylcyclopentylamine, dipropylcyclopentylamines, dibutylcyclopentylamines, dimethylcyclohexylamine, diethylcyclohexylamine, dipropylcyclohexylamines, dimethylcyclopentenylamines, diethylcyclopentenylamines, dipropylcyclopentenylamines, dimethylcyclohexenylamines, diethylcyclohexenylamines, dipropylcyclohexenylamines, methyldicyclopentylamine, ethyldicyclopentylamine, propylcyclopentylamines, methyldicyclohexylamine, ethyldicyclohexylamine, propylcyclohexylamines, methyldicyclopentenylamines, ethyldicyclopentenylamines, propyldicyclopentenylamines, N,N-dimethylaniline, N,N-dimethylbenzylamine, N,N-dimethyltoluidines, N,N-dimethylnaphthylamines, N,N-diethylaniline, N,N-diethylbenzylamine, N,N-diethyltoluidines, N,N-diethylnaphthylamines, N,N-dipropylanilines, N,N-dipropylbenzylamines, N,N-dipropyltoluidines, N,N-dipropylnaphthylamines, N,N-divinylaniline, N,N-diallylaniline, N,N-divinyltoluidines, N,N-diallylaniline, diphenylmethylamine, diphenylethylamine, diphenylpropylamines, dibenzylmethylamine, dibenzylethylamine, dibenzylcyclohexylamine, dibenzylvinylamine, dibenzylallylamine, ditolylmethylamines, ditolylethylamines, ditolylcyclohexylamines, ditolylvinylamines, triphenylamine, tribenzylamine, tri(tolyl)amines, trinaphthylamines, N,N,N′,N′-tetramethylethylenediamine, N,N,N′,N′-tetraethylethylenediamine, N,N,N′,N′-tetramethyltolylenediamines, N,N,N′,N′-tetraethyltolylenediamines, N-methylpyrrole, N-methylpyrrolidine, 2-ethyl-4-methylimidazole, 2-phenylimidazole, 1-(2-cyanoethyl)-2-ethyl-4-methylimidazole, 2-phenylimidazoline, N,N′-dimethylpiperazine, N-methylpiperidine, N-ethylpyrrole, N-methylpyrrolidine, N-ethylimidazole, N,N′-diethylpiperazine, N-ethylpiperidine, pyridine, pyridazine, pyrazine, quinoline, quinazoline, quinuclidine, N-methylpyrrolidone, N-methylmorpholine, N-ethylpyrrolidone, N-ethylmorpholine, N,N-dimethylanisole, N,N-diethylanisole, N,N-dimethylglycine, N,N-diethylglycine, N,N-dimethylalanine, N,N-diethylalanine, N,N-dimethylethanolamine, N,N-dimethylaminothiophene, 1,1,3,3-tetramethylguanidine, 1,8-diazabicyclo[5.4.0]undeca-7-ene, 1,5-diazabicyclo[4.3.0]nona-5-ene, 1,4-diazabicyclo[2.2.2]octane and hexamethylenetetramine etc.

From the viewpoint of the film strength after the thermal crosslinking, 2-ethyl-4-methylimidazole, 2-phenylimidazole, 1-(2-cyanoethyl)-2-ethyl-4-methylimidazole, 2-phenylimidazoline, 1,8-diazabicyclo[5.4.0]undeca-7-ene, 1,5-diazabicyclo[4.3.0]nona-5-ene and 1,1,3,3-tetramethylguanidine are preferable, and 2-ethyl-4-methylimidazole, 2-phenylimidazole, 1,8-diazabicyclo[5.4.0]undeca-7-ene and 1,5-diazabicyclo[4.3.0]nona-5-ene are particularly preferable.

Examples of the inorganic bases include alkali metal hydroxides, alkali metal alkoxides and alkaline earth oxides. Among these, sodium t-butoxide, potassium t-butoxide, sodium methoxide, potassium methoxide, sodium ethoxide and potassium ethoxide are preferable, sodium t-butoxide, potassium t-butoxide, sodium ethoxide and potassium ethoxide are more preferable.

Examples of the quaternary ammonium salts include tetramethylammonium bromide, tetraethylammonium bromide, tetrabutylammonium bromide, tetramethylammonium bromide, benzyltrimethylammonium chloride, benzyltrimethylammonium bromide, decyltrimethylammonium chloride and decyltrimethylammonium bromide etc. Among these, tetramethylammonium bromide, tetraethylammonium bromide and tetrabutylammonium bromide are preferable, and tetraethylammonium bromide is more preferable.

Examples of the quaternary phosphonium salts include tetramethylphosphonium bromide, tetraethylphosphonium bromide, tetrabutylphosphonium bromide, tetramethylphosphonium bromide, benzyltrimethylphosphonium chloride, benzyltrimethylphosphonium bromide, decyltrimethylphosphonium chloride and decyltrimethylphosphonium bromide. Among these, tetramethylphosphonium bromide, tetraethylphosphonium bromide and tetrabutylphosphonium bromide are preferable, and tetraethylphosphonium bromide is more preferable.

With regard to Component D, only one type may be used or two or more types may be used in combination.

The content of Component D contained in the resin composition of the present invention is preferably 0.01 to 20 wt % relative to the total solids content, and more preferably 0.1 to 10 wt %.

### (Component E) A Binder Polymer

The resin composition for laser engraving of the present invention preferably further comprises (Component E) a binder polymer (hereinafter, also referred to as a “binder”).

The binder polymer (Component E) may be added to the resin composition of the present invention for the purpose of improving the film strength and printing durability.

The binder polymer that can be used in the present invention is not particularly limited, but preferably comprises a binder polymer containing a functional group, in a molecule, capable of forming a crosslinked structure as the result of the reaction with at least one of the hydrolyzable silyl group and the silanol group in Component C in point of forming a high three-dimensional crosslinking.

The binder is a polymer component contained in the resin composition for laser engraving, and may appropriately be selected a general polymer, and only one type thereof may be used or two or more types thereof may be used in combination. In particular, when the resin composition for laser engraving is used as the printing plate precursor, it is necessary to select the polymer while considering various performances such as laser engraving properties, ink acceptance properties and engraving residue dispersibility.

As the binder, a material selected from polystyrene resin, polyester resin, polyamide resin, polyurea resin, polyamidoimide resin, polyurethane resin, polysulfone resin, polyethersulfone resin, polyimide resin, polycarbonate resin, hydrophilic polymers containing a hydroxyethylene unit, acrylic resin, acetal resin, epoxy resin, polycarbonate resin, rubber, thermoplastic elastomer etc. may be used.

For example, from the viewpoint of laser engraving sensitivity, said polymer is preferably a polymer containing a partial structure that thermally decomposes upon exposure to light or heating. Preferred examples of such a polymer include those described in paragraph 0038 of JP-A-2008-163081. For the purpose of forming a soft film having flexibility, a soft resin or a thermoplastic elastomer is selected. They are described in detail in paragraphs 0039 and 0040 of JP-A-2008-163081. Furthermore, when the resin composition for laser engraving is applied to a relief-forming layer, from the viewpoint of ease of preparation of a resin composition for laser engraving and improvement of resistance to oil-based ink of a relief printing plate that is obtained, a hydrophilic or alcoholphilic polymer is preferably used. As a hydrophilic polymer, those described in detail in paragraph 0041 of JP-A-2008-163081 may be used.

Similarly, as the polymer that can be used on its own or in combination with the crosslinking polymer, when it is used for the purpose of curing by heat or light exposure and improving strength, a polymer having a carbon-carbon unsaturated bond in the molecule is preferably used.

As a polymer having a carbon-carbon unsaturated bond in the main chain, SI (polystyrene-polyisoprene), SB (polystyrene-polybutadiene), SBS (polystyrene-polybutadiene-polystyrene), SIS (polystyrene-polyisoprene-polystyrene), SEBS (polystyrene-polyethylene/polybutylene-polystyrene), etc. can be cited. Among them, SI is preferably used.

A polymer having a carbon-carbon unsaturated bond in a side chain may be obtained by introducing, into a side chain of the skeleton of the above-mentioned polymer, a carbon-carbon unsaturated bond such as an allyl group, an acryloyl group, a methacryloyl group, a styryl group, or a vinyl ether group. As a method for introducing a carbon-carbon unsaturated bond into a polymer side chain, a known method such as (1) a method in which a polymer is copolymerized with a structural unit having a polymerizable group precursor formed by bonding a protecting group to a polymerizable group, and the protecting group is removed to give a polymerizable group or (2) a method in which a polymer compound having a plurality of reactive groups such as hydroxy groups, amino groups, epoxy groups, or carboxy groups is prepared and a polymer reaction is carried out with a compound having a carbon-carbon unsaturated bond and a group that reacts with these reactive groups may be employed. In accordance with these methods, the amount of unsaturated bond and polymerizable group introduced into the polymer compound can be controlled.

As the binder, the use of a polymer having a hydroxyl group (—OH) (hereinafter, also referred to as the “specific polymer”) is particularly preferable. As the skeleton of the specific polymer, although not particularly limited, an acrylic resin, an epoxy resin, hydrophilic polymers containing a hydroxyethylene unit, a polyvinylacetal resin, a polyester resin and a polyurethane resin are preferable.

Examples of the acrylic monomers used for synthesizing an acrylic resin having a hydroxyl group include preferably (meth)acrylic acid esters, crotonic acid esters and (meth)acrylamides having a hydroxyl group in the molecule. Specific examples of such monomers include 2-hydroxyethyl (meth)acrylate, 2-hydroxypropyl (meth)acrylate, 4-hydroxybutyl (meth)acrylate etc. Copolymers obtained by copolymerizing these with a known (meth)acrylic-based monomer or vinyl-based monomer are used preferably.

As the specific polymer, the use of an epoxy resin having a hydroxyl group on the side chain may also be possible. As a preferable specific example, an epoxy resin obtained by polymerizing an adduct of bisphenol A and epichlorohydrin as raw material monomers is cited.

As the polyester resin, a polyester resin containing a hydroxycarboxylic acid unit such as polylactic acid is preferably used. Specifically, the polyester resin selected from the group consisting of polyhydroxy alkanoate (PHA), lactic acid-based polymer, polyglycolic acid (PGA), polycaprolactone (PCL), poly(butylenesuccinic acid), derivatives and mixtures thereof is preferable.

As the specific polymer, a polymer having an atom and/or a group capable of reacting with the above-mentioned compound (I) is preferable, and a binder polymer that has an atom and/or a group capable of reacting with the compound (I) and is insoluble in water and soluble in an alcohol having 1 to 4 carbon atoms is more preferable.

Examples of the atom and/or the group capable of reacting with the compound (I) include, although not particularly limited, an ethylenically unsaturated bond, an epoxy group, an amino group, a (meth)acryloyl group, a mercapto group and a hydroxyl group, and, among these, a hydroxyl group is exemplified preferably.

Examples of preferable specific polymers in the present invention include polyvinyl butyral (PVB), acrylic resin having a hydroxyl group on the side chain, epoxy resin having a hydroxyl group on the side chain etc., from the viewpoint of having high engraving sensitivity and good film performance while satisfying both the aptitude for an aqueous ink and the aptitude for a UV ink.

The specific polymer usable for the present invention gives particularly preferably a glass transition temperature (Tg) of at least 20° C., when combined with a photothermal conversion agent capable of absorbing light having a wavelength of 700 to 1,300 nm to be described later, which is a preferable combining component of the resin composition for laser engraving constituting the recording layer in the present invention, because the engraving sensitivity is improved. Hereinafter, the polymer having such glass transition temperature is referred to as a non-elastomer. That is, the elastomer is generally defined scientifically as a polymer having a glass transition temperature that is no greater than normal temperature (20° C.) (see Kagaku Daijiten (comprehensive dictionary of science), P154, second edition, edited by Foundation for Advancement of International Science, published by Maruzen Co., Ltd.). Accordingly, the non-elastomer denotes polymers having a glass transition temperature that is greater than ordinary temperature. Although the upper limit of the glass transition temperature of the specific polymer is not particularly limited, it is preferably no greater than 200° C. from the viewpoint of handling properties, and more preferably at least 25° C. but no greater than 120° C.

When a polymer having a glass transition temperature of 20° C. (normal temperature) or greater is used, the specific polymer is in a glass state at normal temperature. Because of this, compared with a case of the rubber state, thermal molecular motion is suppressed. In laser engraving, in addition to the heat given by a laser during laser irradiation, heat generated by the function of a photothermal conversion agent added as desired is transmitted to the surrounding specific polymer, and this polymer is thermally decomposed and disappears, thereby forming an engraved recess.

When the specific polymer is used, it is surmised that when a photothermal conversion agent is present in a state in which thermal molecular motion of the specific polymer is suppressed, heat transfer to and thermal decomposition of the specific polymer occur effectively. It is anticipated that such an effect further increases the engraving sensitivity.

Examples of the binder that can be preferably used in the present invention are shown below.

Polyvinyl acetal is a compound obtained by converting polyvinyl alcohol (obtained by saponifying polyvinyl acetate) into a cyclic acetal. A polyvinyl acetal derivative is a polymer that polyvinyl acetal is modified, or a polyvinyl acetal having another copolymerization component.

The acetal content in the polyvinyl acetal (mole % of vinyl alcohol units converted into acetal with the total number of moles of vinyl acetate monomer starting material as 100%) is preferably 30 to 90%, more preferably 50 to 85%, and particularly preferably 55 to 78%.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal derivative may further have another copolymerization unit.

Examples of the polyvinyl acetal include polyvinyl butyral, polyvinyl propylal, polyvinyl ethylal, and polyvinyl methylal. Among them, polyvinyl butyral (PVB) is preferable.

Polyvinyl butyral is a polymer obtained by a reaction polyvinyl alcohol and butyl aldehyde. A polyvinyl butyral derivative may be used.

Examples of the polyvinyl butyral derivatives include an acid-modified PVB in which at least some of the hydroxy groups of the hydroxyethylene units are modified with an acid group such as a carboxy group, a modified PVB in which some of the hydroxy groups are modified with a (meth)acryloyl group, a modified PVB in which at least some of the hydroxy groups are modified with an amino group, and a modified PVB in which at least some of the hydroxy groups have introduced thereinto ethylene glycol, propylene glycol, or a multimer thereof.

From the viewpoint of a balance being achieved between engraving sensitivity and film formation properties, the molecular weight of the polyvinyl acetal is preferably 5,000 to 800,000 as the weight-average molecular weight, more preferably 8,000 to 500,000 and, from the viewpoint of improvement of rinsing properties for engraving residue, particularly preferably 50,000 to 300,000.

Particularly preferable examples of the polyvinyl acetal are explained below by polyvinyl butyral (PVB) and the derivatives thereof, but the polyvinyl acetal should not be construed as being limited to the Examples.

Polyvinyl butyral derivatives are commercially available and preferable examples from viewpoint of solubility in alcohol, particularly in ethanol, are the ‘E-LEC B’ series and the ‘E-LEC K (KS)’ series manufactured by Sekisui Chemical co., Ltd., the Denka Butyral series manufactured by Denki Kagaku Kogyo Kabushiki Kaisha. From the viewpoint of alcohol solubility (particularly in ethanol), the polyvinyl butyral is preferably the ‘S-LEC B’ series and the ‘S-LEC K(KS)’ series manufactured by Sekisui Chemical Co., Ltd. From the viewpoint of alcohol solubility (particularly in ethanol), the ‘S-LEC B’ series manufactured by Sekisui Chemical Co., Ltd. and ‘Denka Butyral’ manufactured by Denki Kagaku Kogyo Kabushiki Kaisha are more preferable; among the ‘S-LEC B’ series, ‘BL-1’, ‘BL-1H’, ‘BL-2’, ‘BL-5’, ‘BL-S’, ‘BX-L’, ‘BM-S’, and ‘BH-S’ are particularly preferable, and among the ‘Denka Butyral’ manufactured by Denki Kagaku Kogyo Kabushiki Kaisha ‘#3000-1’, ‘#3000-2’, ‘#3000-4’, ‘#4000-2’, ‘#6000-C’, ‘#6000-EP’, ‘#6000-CS’, and ‘#6000-AS’ are particularly preferable.

When manufacturing a relief-forming layer from PVB as the specific polymer, casting and drying of a solution in a solvent is preferable from viewpoint of flatness of the film surface.

In addition to the polyvinylacetal and derivatives thereof, as the specific polymer, it is also possible to use an acrylic resin that is obtained by using a known acrylic monomer and has a hydroxyl group in a molecule. Furthermore, as the specific polymer, a novolac resin that is a resin obtained by condensing phenols and aldehydes under an acidic condition may also be used. Moreover, as the specific polymer, an epoxy resin having a hydroxyl group on a side chain may also be used.

Among the specific polymers, polyvinyl butyral and derivatives thereof are particularly preferable from the viewpoint of rinsing properties and printing durability when made into a recording layer.

The content of a hydroxyl group contained in the specific polymer in the present invention is preferably 0.1 to 15 mmol/g, and more preferably 0.5 to 7 mmol/g, in the polymer of any embodiment described above.

With regard to the binder in the resin composition, only one type may be used or two or more types may be used in combination.

The weight average molecular weight of the binder that can be used in the present invention (on a polystyrene basis by GPC measurement) is preferably 5,000 to 1,000,000, more preferably 8,000 to 750,000, and most preferably 10,000 to 500,000.

From the viewpoint of satisfying the shape retention, water resistance and engraving sensitivity of the coated film in a balanced manner, the content of the specific polymer in the resin composition employable in the present invention is, in the total solids content, preferably 2 to 95 wt %, more preferably 5 to 80 wt %, and particularly preferably 10 to 60 wt %.

From the viewpoint of satisfying the shape retention, water resistance and engraving sensitivity of the coated film in a balanced manner, the content of Component E is, relative to the total solids content of the resin composition, preferably in a range of 0 to 80 wt %, more preferably in a range of 5 to 60 wt %, and particularly preferably in a range of 10 to 40 wt %.

### (Component F) a Photothermal Conversion Agent

The resin composition for laser engraving of the present invention preferably further comprises (Component F) a photothermal conversion agent. That is, It is surmised that the photothermal conversion agent in the present invention absorbs laser light and generates heat thus promoting thermal decomposition of a cured material of the resin composition for laser engraving of the present invention. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the relief-forming layer in the present invention to comprise a photothermal conversion agent that can absorb light having a wavelength of 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium dyes, pyrylium salts, and metal thiolate complexes. In particular, cyanine-based dyes such as heptamethine cyanine dyes, oxonol-based dyes such as pentamethine oxonol dyes, and phthalocyanine-based dyes are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include those described in paragraphs 0130 to 0134 of JP-A-2009-178869.

The content of the photothermal conversion agent in the resin composition for laser engraving of the present invention largely depends on the size of the molecular extinction coefficient characteristic to the molecule, and is preferably 0.01 to 230 wt % relative to the total weight of the solids content of the resin composition, more preferably 0.05 to 20 wt %, and yet more preferably 0.1 to 10 wt %.

### (Component G) An Alcohol Exchange Reaction Catalyst

The resin composition of the present invention preferably further comprises (Component G) an alcohol exchange reaction catalyst. The alcohol exchange reaction catalyst is a compound that can promote a reaction between a hydrolyzable silyl group and/or a silanol group in Component C, and hydroxyl group, and examples thereof preferably include an acidic or basic catalyst and a metal complex catalyst.

When Component B or Component D is an acid or a base, these may be function as Component G.

### <Metal Complex Catalyst>

The metal complex catalyst that can be used as an alcohol exchange reaction catalyst in the present invention is preferably constituted from a metal element selected from Groups 2, 4, 5, and 13 of the periodic table and an oxo or hydroxy oxygen compound selected from β-diketones, ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti is excellent and preferable, ethyl orthotitanate, etc. is more preferable.

In the present invention, examples of the oxo or hydroxy oxygen-containing compound constituting a ligand of the above-mentioned metal complex include β-diketones such as acetylacetone (2,4-pentanedione) and 2,4-heptanedione, ketoesters such as methyl acetoacetate, ethyl acetoacetate, and butyl acetoacetate, hydroxycarboxylic acids and esters thereof such as lactic acid, methyl lactate, salicylic acid, ethyl salicylate, phenyl salicylate, malic acid, tartaric acid, and methyl tartarate, ketoalcohols such as 4-hydroxy-4-methyl-2-pentanone, 4-hydroxy-2-pentanone, 4-hydroxy-4-methyl-2-pentanone, and 4-hydroxy-2-heptanone, amino alcohols such as monoethanolamine, N,N-dimethylethanolamine, N-methylmonoethanolamine, diethanolamine, and triethanolamine, enolic active compounds such as methylolmelamine, methylolurea, methylolacrylamide, and diethyl malonate ester, and compounds having a substituent on the methyl group, methylene group, or carbonyl carbon of acetylacetone.

A preferred ligand is an acetylacetone derivative, and the acetylacetone derivative in the present invention means a compound having a substituent on the methyl group, methylene group, or carbonyl carbon of acetylacetone. The substituent with which the methyl group of acetylacetone is substituted is a straight-chain or branched alkyl group, acyl group, hydroxyalkyl group, carboxyalkyl group, alkoxy group, or alkoxyalkyl group that all have 1 to 3 carbon atoms, the substituent with which the methylene carbon of acetylacetone is substituted is a carboxy group or a straight-chain or branched carboxyalkyl group or hydroxyalkyl group having 1 to 3 carbon atoms, and the substituent with which the carbonyl carbon of acetylacetone is substituted is an alkyl group having 1 to 3 carbon atoms, and in this case the carbonyl oxygen turns into a hydroxy group by addition of a hydrogen atom.

Specific preferred examples of the acetylacetone derivative include acetylacetone, ethylcarbonylacetone, n-propylcarbonylacetone, i-propylcarbonylacetone, diacetylacetone, 1-acetyl-1-propionylacetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol, and among them acetylacetone and diacetylacetone are preferable. The complex of the acetylacetone derivative and the metal element is a mononuclear complex in which 1 to 4 molecules of acetylacetone derivative coordinate to one metal element, and when the number of coordinatable sites of the metal element is larger than the total number of coordinatable bond sites of the acetylacetone derivative, a ligand that is usually used in a normal complex, such as a water molecule, a halide ion, a nitro group, or an ammonio group may coordinate thereto.

Preferred examples of the metal complex include a tris(acetylacetonato)aluminum complex salt, a di(acetylacetonato)aluminum-aqua complex salt, a mono(acetylacetonato)aluminum-chloro complex salt, a di(diacetylacetonato)aluminum complex salt, ethyl acetoacetate aluminum diisopropylate, aluminum tris(ethyl acetoacetate), cyclic aluminum oxide isopropylate, a tris(acetylacetonato)barium complex salt, a di(acetylacetonato)titanium complex salt, a tris(acetylacetonato)titanium complex salt, a di-1-propoxy-bis(acetylacetonato)titanium complex salt, zirconium tris(ethyl acetoacetate), and a zirconium tris(benzoic acid) complex salt. They are excellent in terms of stability in an aqueous coating solution and an effect in promoting gelling in a sol-gel reaction when thermally drying, and among them ethyl acetoacetate aluminum diisopropylate, aluminum tris(ethyl acetoacetate), a di(acetylacetonato)titanium complex salt, and zirconium tris(ethyl acetoacetate) are particularly preferable.

The resin composition of the present invention may employ only one type of (Component G) an alcohol exchange reaction catalyst or two or more types thereof in combination.

The content of (Component G) an alcohol exchange reaction catalyst in the resin composition is not particularly limited, and may be selected appropriately in accordance with characteristics of the alcohol exchange reaction catalyst to be used.

### <Solvent>

The resin composition of the present invention may comprise a solvent.

From the viewpoint of solubility of each components, a solvent used when preparing the resin composition for laser engraving of the present invention is preferably mainly an aprotic organic solvent. More specifically, they are used preferably at aprotic organic solvent/protic organic solvent=100/0 to 50/50 (ratio by weight), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among them, propylene glycol monomethyl ether acetate is preferable.

### <Other Additives>

To the resin composition for laser engraving of the present invention, additives other than Component A to Component G may be added suitably in a range that does not hinder the effect of the present invention. Examples thereof include a fragrance, a polymerizable compound, a polymerization initiator, a filler, a plasticizer, wax, a process oil, an organic acid, a metal oxide, an ozone decomposition inhibitor, an antioxidant, a thermal polymerization inhibitor, a colorant etc. With regard to these additives, only one type may be used or two or more types may be used in combination.

The resin composition for laser engraving of the present invention contains preferably a plasticizer. The plasticizer is a material having the function of softening the film formed with the resin composition for laser engraving, and has necessarily a good compatibility relative to the binder polymer.

As the plasticizer, for example, dioctyl phthalate, didodecyl phthalate, polyethylene glycols, and polypropylene glycols (such as monool type and diol type) are used preferably.

The resin composition for laser engraving of the present invention preferably comprises, as an additive for improving engraving sensitivity, nitrocellulose or a high thermal conductivity material. Since nitrocellulose is a self-reactive compound, it generates heat during laser engraving, thus assisting thermal decomposition of a coexisting binder polymer such as a hydrophilic polymer. It is surmised that as a result, the engraving sensitivity improves. A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer or a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition.

For the purpose of coloring the resin composition for laser engraving, a colorant such as a dye or a pigment may be added. This enables properties such as visibility of an image area or suitability for an image densitometer to improve.

Furthermore, in order to improve physical properties of a cured film of the resin composition for laser engraving, a known additive such as a filler may be added.

### (Relief Printing Plate Precursor for Laser Engraving)

A first embodiment of the relief printing plate precursor for laser engraving of the present invention comprises a relief-forming layer formed from the resin composition for laser engraving of the present invention.

A second embodiment of the relief printing plate precursor for laser engraving of the present invention comprises a crosslinked relief-forming layer formed by crosslinking a relief-forming layer formed from the resin composition for laser engraving of the present invention.

In the present invention, the ‘relief printing plate precursor for laser engraving’ means both or one of a plate having a crosslinkable relief-forming layer formed from the resin composition for laser engraving in a state before being crosslinked and a plate in a state in which it is cured by light and/or heat.

The relief printing plate precursor for laser engraving of the present invention is preferably a relief printing plate precursor having crosslinked relief-forming layer crosslinked by heat.

In the present invention, the ‘relief-forming layer’ means a layer in a state before being crosslinked, that is, a layer formed from the resin composition for laser engraving of the present invention, which may be dried as necessary.

In the present invention, the ‘crosslinked relief-forming layer’ means a layer formed by crosslinking the relief-forming layer. The crosslinking is preferably carried out by means of heat and/or light. Furthermore, the crosslinking is not particularly limited as long as it is a reaction by which the resin composition is cured, and it is a concept that includes a structure crosslinked due to reactions between Component A's, Component A and B and/or Component A to C, and the crosslinking may be form a crosslinked structure by a reaction between Component A to C and other Component. When polymerizable compound is used, the crosslinking include a crosslinking by polymerization.

The ‘relief printing plate’ is prepared by laser engraving a printing plate precursor having a crosslinked relief-forming layer.

Moreover, in the present invention, the ‘relief layer’ means a layer of the relief printing plate formed by engraving using a laser, that is, the crosslinked relief-forming layer after laser engraving.

A relief printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) relief printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention and is a crosslinkable layer.

As a mode in which a relief printing plate is prepared using the relief printing plate precursor for laser engraving, a mode in which a relief printing plate is prepared by crosslinking a relief-forming layer to thus form a relief printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a relief printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

A case in which the relief-forming layer is mainly formed in a sheet shape is explained as an Example below.

### <Support>

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Relief Printing Plate Precursor for Laser Engraving)

Formation of a relief-forming layer in the relief printing plate precursor for laser engraving is not particularly limited, and examples thereof include a method in which the resin composition for laser engraving is prepared, solvent is removed as necessary from this resin composition for laser engraving, and it is melt-extruded onto a support. Alternatively, a method may be employed in which the resin composition for laser engraving is cast onto a support, and this is dried in an oven to thus remove solvent from the resin composition.

Among them, the process for making a relief printing plate for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a relief printing plate precursor having a crosslinked relief-forming layer, and more preferably a production process comprising a layer formation step of forming a relief-forming layer from the resin composition for laser engraving of the present invention and a crosslinking step of crosslinking the relief-forming layer by means of heat to thus obtain a relief printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for making the relief printing plate for laser engraving of the present invention preferably comprises a layer formation step of forming a relief-forming layer from the resin composition for laser engraving of the present invention.

Preferred examples of a method for forming a relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove the solvent.

The resin composition for laser engraving may be preferably produced by, for example, dissolving Component A and C, and as optional components Component D to G etc. in an appropriate solvent, and then dissolving Component B.

The thickness of the (crosslinked) relief-forming layer in the relief printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

### <Crosslinking Step>

The process for producing a relief printing plate precursor for laser engraving of the present invention is preferably a production process comprising a crosslinking step of crosslinking the relief-forming layer by means of light and/or heat to thus obtain a relief printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises a thermopolymerization initiator (it being possible for the above-mentioned photopolymerization initiator to function also as a thermopolymerization initiator), the relief-forming layer may be crosslinked by heating the relief printing plate precursor for laser engraving (step of crosslinking by means of heat). As heating means, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of the general properties of a material, the lower the molecular weight, the more easily it becomes a liquid rather than a solid, that is, there is a tendency for tackiness to be stronger. Engraving residue formed when engraving a relief-forming layer tends to have higher tackiness the more that low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

### (Relief Printing Plate and Process for Making Same)

The process for making a relief printing plate of the present invention preferably comprises a layer formation step of forming a relief-forming layer from the resin composition for laser engraving of the present invention, a crosslinking step of crosslinking the relief-forming layer by means of heat and/or light to thus obtain a relief printing plate precursor having a crosslinked relief-forming layer, and an engraving step of laser-engraving the relief printing plate precursor having the crosslinked relief-forming layer, and more preferably comprises a layer formation step of forming a relief-forming layer from the resin composition for laser engraving of the present invention, a crosslinking step of crosslinking the relief-forming layer by means of heat to thus obtain a relief printing plate precursor having a crosslinked relief-forming layer, and an engraving step of laser-engraving the relief printing plate precursor having the crosslinked relief-forming layer.

The relief printing plate of the present invention is a relief printing plate having a relief layer obtained by crosslinking and laser-engraving a layer formed from the resin composition for laser engraving of the present invention, and is preferably a relief printing plate made by the process for making a relief printing plate of the present invention.

The layer formation step and the crosslinking step in the process for making a relief printing plate of the present invention mean the same as the layer formation step and the crosslinking step in the above-mentioned process for producing a relief printing plate precursor for laser engraving, and preferred ranges are also the same.

### <Engraving Step>

The process for making a relief printing plate of the present invention preferably comprises an engraving step of laser-engraving the relief printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, and ‘Applied Laser Technology’ The Institute of Electronics and Communication Engineers, etc.

Moreover, as plate making equipment comprising a fiber-coupled semiconductor laser that can be used suitably in the process for making a relief printing plate employing the relief printing plate precursor of the present invention, those described in detail in JP-A-2009-172658 and JP-A-2009-214334 can be cited.

The process for making a relief printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid containing water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid containing water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin relief printing plate precursor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 6, more preferably at least 6.5, and yet more preferably at least 11. The pH of the rinsing liquid is preferably no greater than 14, more preferably no greater than 13.5, yet more preferably no greater than 13.1. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, amphoteric surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 weight % relative to the total weight of the rinsing liquid, and more preferably 0.05 to 10 weight %.

The relief printing plate of the present invention having a relief layer on the surface of any substrate such as a support etc. may be produced as described above.

From the viewpoint of satisfying suitability for various aspects of printing, such as abrasion resistance and ink transfer properties, the thickness of the relief layer of the relief printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness at 25° C. of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured at 25° C. by a durometer (a spring type rubber hardness meter) that presses an indenter (called a pressing needle or indenter) into the surface of a measurement target so as to deform it, measures the amount of deformation (indentation depth), and converts it into a numerical value.

The relief printing plate of the present invention is particularly suitable for printing by a flexographic printer using an aqueous ink, but printing is also possible when it is carried out by a relief printer using any of aqueous, oil-based, and UV inks, and printing is also possible when it is carried out by a flexographic printer using a UV ink. The relief printing plate of the present invention has excellent rinsing properties, there is no engraving residue, since a relief layer obtained has excellent elasticity aqueous ink transfer properties and printing durability are excellent, and printing can be carried out for a long period of time without plastic deformation of the relief layer or degradation of printing durability.

In accordance with the present invention, there can be provided a resin composition for laser engraving capable of giving a relief printing plate excellent in film elasticity, printing durability and aqueous ink transfer properties, a relief printing plate precursor using the resin composition for laser engraving, a process for making a relief printing plate using the same, and a relief printing plate obtained thereby.

### EXAMPLES

The present invention is explained in further detail below by reference to Examples, but the present invention should not be construed as being limited to these Examples.

The weight-average molecular weight (Mw) of a polymer in the Examples is a value measured by a GPC method unless otherwise specified.

### Example 1

### 1. Preparation of a Resin Composition for Laser Engraving

A three-necked flask provided with a stirring blade and a condenser was charged with 46 parts of trimethylolpropane triglycidyl ether (Aldrich) (A-1) as Component A, 51 parts of propylene glycol monomethyl ether acetate as a solvent, 30 parts of the compound (S-1) as Component C, and 3 parts of ketjen black EC600JD (carbon black, Lion Corporation) as a photothermal conversion agent (Component F), which was stirred at 25° C. for 10 min. After that, as Component B, 21 parts of hexanediamine (Tokyo Chemical Industry, meanwhile, also functions as Component G) (B-1-1) was charged, which was stirred at 40° C. for 10 min. This operation gave a flowable coating liquid 1 (resin composition for laser engraving) for a crosslinkable relief-forming layer.

### 2. Preparation of a Relief Printing Plate Precursor for Laser Engraving

A spacer (frame) having a predetermined thickness was placed on a PET substrate, the coating solution 1 for a crosslinkable relief-forming layer obtained above was cast gently so that it did not overflow from the spacer (frame), and dried in an oven at 90° C. for 1.5 hr to provide a relief-forming layer having a thickness of about 1 mm, thus preparing a relief printing plate precursor 1 for laser engraving.

### 3. Preparation of a Relief Printing Plate

The relief-forming layer of the plate precursor thus obtained was heated at 100° C. for 5 hr to thus thermally crosslink furthermore the relief-forming layer.

The crosslinked relief-forming layer after the crosslinking was subjected to engraving by two types of lasers below.

As a carbon dioxide laser engraving machine, a high-definition CO₂ laser marker ML-9100 series (Keyence Corporation) was used. After a protection film was peeled off from the printing plate precursor 1 for laser engraving, a solid print portion of 1 cm square was raster-engraved using the carbon dioxide laser engraving machine under conditions of an output of 12 W, a head speed of 200 mm/sec, and a pitch setting of 2,400 DPI.

As a semiconductor laser engraving machine, laser recording equipment provided with a fiber-coupled semiconductor laser (FC-LD) SDL-6390 (JDSU, wavelength 915 nm) with a maximum power of 8.0 W was used. A solid print portion of 1 cm square was raster-engraved using the semiconductor laser engraving machine under conditions of a laser output of 7.5 W, a head speed of 409 mm/sec, and a pitch setting of 2,400 DPI.

The thickness of the relief layer of the relief printing plate was about 1 mm.

Furthermore, when the Shore A hardness of the relief layer was measured by the above-mentioned measurement method, it was found to be 55°. Measurement of the Shore hardness A was carried out in the same manner in each of the Examples and Comparative Examples described below.

### Example 2

### 1. Preparation of Resin Composition for Laser Engraving

A three-necked flask provided with a stirring blade and a condenser was charged with 30 parts of “Denka Butyral #3000-2” (Denki Kagaku Kogyo K.K., polyvinyl butyral derivative, Mw=90,000) as Component E, 23 parts of trimethylolpropanetriglycidyl ether (Aldrich) (A-1) as Component A, 51 parts of propylene glycol monomethyl ether acetate as a solvent, furthermore 30 parts of the compound (S-1) as Component C, and 3 parts of ketjen black EC600JD (carbon black, Lion Corporation) as a photothermal conversion agent (Component F), which was stirred at 25° C. for 10 min. After that, as Component B, 10 parts of hexanediamine (meanwhile, also acts as Component G) (B-1-1) was charged, which was stirred at 40° C. for 10 min. This operation gave a flowable coating liquid 2 (resin composition for laser engraving) for a crosslinkable relief-forming layer.

### 2. Preparation of a Relief Printing Plate Precursor for Laser Engraving

It was prepared in the same manner as that in Example 1.

### 3. Preparation of a Relief Printing Plate

It was prepared in the same manner as that in Example 1. The thickness of the relief layer of the relief printing plate was about 1 mm.

Furthermore, when the Shore A hardness of the relief layer was measured by the above-mentioned measurement method, it was found to be 75°.

### Examples 3 to 11

The same procedure as that in Example 2 was repeated except for replacing Component A, Component B and Component E used in Example 2 with Component A, Component B and Component E listed in Table 1 below, respectively, (meanwhile, the molar equivalent ratio of functional groups of Component A and Component B was set to be constant) to thus prepare coating liquids for crosslinkable relief-forming layers (resin compositions for laser engraving) 3 to 11, and relief printing plate precursors for laser engraving and relief printing plates were prepared. The thickness of the relief layers in the relief printing plates was about 1 mm.

### Example 12

### 1. Preparation of a Crosslinkable Resin Composition for Laser Engraving

A three-necked flask provided with a stirring blade and a condenser was charged with 30 parts of “Denka Butyral #3000-2” (Denki Kagaku Kogyo K.K., polyvinyl butyral derivative, Mw=90,000) as Component E, 13 parts of trimethylolpropanetriglycidyl ether (Aldrich) (A-1) as Component A, 51 parts of propylene glycol monomethyl ether acetate as a solvent, furthermore 30 parts of the compound (S-1) (available from Shin-Etsu Chemical Co., Ltd. as a trade name KBE-846) as Component C, and 3 parts of ketjen black EC600JD (carbon black, Lion Corporation) as a photothermal conversion agent (Component F), which was stirred at 25° C. for 10 min. After that, 17 parts of tetrahydrophthalic anhydride (New Japan Chemical Co., Ltd.) (B-2-1) was charged as Component B, and, as Component D, 7 parts of 1,8-diazabicyclo[5.4.0]-7-undecene (DBU) (Tokyo Chemical Industry, meanwhile it acts as Component G) was charged, which was stirred at 40° C. for 10 min. This operation gave a flowable coating liquid 13 (resin composition for laser engraving) for a crosslinkable relief-forming layer.

### 2. Preparation of a Relief Printing Plate Precursor for Laser Engraving

It was prepared in the same manner as that in Example 1.

### 3. Preparation of a Relief Printing Plate

It was prepared in the same manner as that in Example 1. The thickness of the relief layer in the relief printing plate was about 1 mm. Moreover, when the Shore A hardness of the relief layer was measured by the above-mentioned measurement method, it was found to be 85°.

In any of following Examples and Comparative Examples, the thickness of the relief layer in the relief printing plate was about 1 mm.

### Examples 13 to 26

The same procedure as that in Example 12 was repeated except for replacing Component B and Component D used in Example 12 with Component B and Component D listed in Table 1 below, respectively, (meanwhile, the molar equivalent ratio of functional groups of Component A and Component B was set to be constant) to thus prepare coating liquids for crosslinkable relief-forming layers (resin compositions for laser engraving) 13 to 26, and relief printing plate precursors for laser engraving and relief printing plates were prepared.

### Examples 27 to 29

The same procedure as that in Example 2 was repeated except for adding 1 part of Component D listed in Table 1 below, respectively, to Example 2 at the same time as Component B to thus prepare coating liquids for crosslinkable relief-forming layers (resin compositions for laser engraving) 27 to 29, and relief printing plate precursors for laser engraving and relief printing plates were prepared.

### Examples 30 and 31

The same procedure as that in Example 2 was repeated except for adding 5 parts of Component D listed in Table 1 below, respectively, to Example 2 at the same time as Component B, to thus prepare coating liquids for crosslinkable relief-forming layers (resin compositions for laser engraving) 30 and 31, and relief printing plate precursors for laser engraving and relief printing plates were prepared.

### (Examples 32 to 35)

The same procedure as that in Example 2 was repeated except for replacing Component C used in Example 2 with Component C listed in Table 1, respectively, and adding 2 parts of Component G to thus prepare coating liquids for crosslinkable relief-forming layers (resin compositions for laser engraving) 32 to 35, and relief printing plate precursors for laser engraving and relief printing plates were prepared.

### Comparative Example 1

The same procedure as that in Example 1 was repeated except for removing Component C used in Example 1 to thus prepare a coating liquid for a crosslinkable relief-forming layer (resin composition for laser engraving) C1, and a relief printing plate precursor for laser engraving and a relief printing plate were prepared.

### Comparative Example 2

The same procedure as that in Example 2 was repeated except for removing Component C used in Example 2 to thus prepare a coating liquid for a crosslinkable relief-forming layer (resin composition for laser engraving) C2, and a relief printing plate precursor for laser engraving and a relief printing plate were prepared.

### Comparative Example 3

The same procedure as that in Example 12 was repeated except for removing Component A, Component B and Component E used in Example 12 to thus prepare a coating liquid for a crosslinkable relief-forming layer (resin composition for laser engraving) C3, and a relief printing plate precursor for laser engraving and a relief printing plate were prepared.

### Comparative Example 4

The same procedure as that in Example 12 was repeated except for removing Component A and Component B used in Example 12 to thus prepare a coating liquid for a crosslinkable relief-forming layer (resin composition for laser engraving) C4, and a relief printing plate precursor for laser engraving and a relief printing plate were prepared.

### Comparative Example 5

The same procedure as that in Example 12 was repeated except for removing Component B and Component E used in Example 12 to thus prepare a coating liquid for a crosslinkable relief-forming layer (resin composition for laser engraving) C5, and a relief printing plate precursor for laser engraving and a relief printing plate were prepared.

### Comparative Example 6

The same procedure as that in Example 16 was repeated except for removing Component B used in Example 16 to thus prepare a coating liquid for a crosslinkable relief-forming layer (resin composition for laser engraving) C6, and a relief printing plate precursor for laser engraving and a relief printing plate were prepared.

### (Comparative Examples 7 to 9)

The same procedure as that in Example 1 was repeated except for replacing Component A used in Example 1 with those listed in Table 1 below, respectively, to thus prepare coating liquids for crosslinkable relief-forming layers (resin compositions for laser engraving) C7 to C9, and relief printing plate precursors for laser engraving and relief printing plates were prepared.

### Comparative Examples 10 to 14

The same procedure as that in Example 1 was repeated except for replacing Component B, Component D and Component G used in Example 1 with those listed in Table 1 below, respectively, to thus prepare coating liquids for crosslinkable relief-forming layers (resin compositions for laser engraving) C10 to C14, and relief printing plate precursors for laser engraving and relief printing plates were prepared.

### 4. Evaluation of Relief Printing Plate

The performance of relief printing plates was evaluated on items below. Results are shown in Table 2.

### (4-1) Depth of Engraving

“Depth of engraving” of relief layers obtained by subjecting relief-forming layers of relief printing plate precursors 1 to 35, and C1 to C14 to the laser engraving were measured as follows. Here, the “depth of engraving” means the difference between the position (height) having been engraved and the position (height) of not engraved, when the cross-section of the relief layer is observed. The “depth of engraving” in Examples and Comparative Examples were measured by observing the cross-section of the relief layer with an ultra-deep color 3-D profile measuring microscope VK9510 (Keyence Corporation). A larger depth of engraving means a higher engraving sensitivity. Results are shown in Table 2 for every type of lasers used for the engraving.

### (4-2) Evaluation of Rinsing Properties

A rinsing liquid was prepared by mixing water, a 10 wt % aqueous sodium hydroxide solution, and a betaine compound (1-B) below so that pH was 13.1 and the content of the betaine compound (1-B) was 1 wt % relative to the total rinsing liquid.

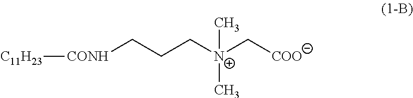

The prepared rinsing liquid was dropped (about 100 ml/m²) with a dropper onto respective plate materials engraved by the above-mentioned method so as to wet uniformly the surface of the plate, which was left at rest for 1 min, and the surface was scrubbed 20 times (30 sec) in parallel to the plate using a toothbrush (Clinica Toothbrush Flat, Lion Corporation) with a load of 200 g. After that, the plate surface was washed with flowing water, moisture of the plate surface was removed, which was naturally dried for around 1 hr.

The surface of the plate after the rinsing was observed with a microscope having a magnification of 100 (Keyence Corporation) to evaluate left behind residues. A residue-free plate is denoted by A, a plate with little residue is denoted by B, a plate with a small amount of residue is denoted by C, and a plate from which residue is not removed is denoted by D.

### (4-3) Film Elasticity

The film elasticity of relief-forming layers in relief printing plate precursors 1 to 35 and C1 to C14 was measured using a micro hardness tester (dynamic hardness tester (Shimadzu)) under conditions of a test load: 1.0 mN, a loading rate: 0.023699 mN/sec, retention time: 5 sec, and a variation scale: 10 μm. Results were represented by a plastic deformation ratio before and after the push. The measurement was performed three times, and the average thereof is listed.

### (4-4) Printing Durability

The obtained relief printing plate was set on a printing machine (Model ITM-4, IYO KIKAI SEISAKUSHO Co., Ltd.), and, while using an aqueous ink, Aqua SPZ16 rouge (Toyo Ink Mfg. Co., Ltd.) without dilution as an ink and using full color form M 70 (thickness 100 μm, Nippon Paper Industries Co., Ltd.) as printing paper, the printing was continued, and highlights 1 to 10% were checked in a printed matter. Timing when a part with a not printed dot occurred was defined as the end of the printing, and the length (meter) of the paper printed until the end of the printing was used as an index. It is evaluated that a larger numeral means better printing durability.

### (4-5) Ink Transfer Properties

In the evaluation of the printing durability above, the level of ink adherence in a solid part was compared visually on printed matters at 500 m and 1,000 m from the start of the printing.

Results were evaluated by five steps, that is, a printed matter unevenness-free and uniform in density was denoted by A, the matter with unevenness was denoted by C, and intermediate levels were denoted by AB, B, and BC in this order from A side.

(4-6) Aqueous ink resistance

### <Swelling Ratio>

The obtained relief printing plate precursors 1 to 35, and C1 to C14 were weighed, immersed in an aqueous ink Aqua SPZ16 rouge (Toyo Ink Mfg. Co., Ltd.) for 120 min, and washed. Furthermore, the moisture on the surface was removed sufficiently with a dry cloth, and the weight was measured. The swelling ratio is shown by a formula below.

Swelling ratio=(weight after cloth drying/weight before operation)×100(%)

It is evaluated that a numeral nearer to 100 means a better aqueous ink resistance.

### <Residual Film Ratio>

The samples after the weighing above were dried at 120° C. for 60 min and weighed. The residual film ratio is shown by a formula below.

Residual film ratio=(weight after drying/weight before operation)×100(%)

It is evaluated that a numeral nearer to 100 means a better aqueous ink resistance.

TABLE 1

| | Component A | Component B | Component C | Component D | Component E | Component G |
|---|---|---|---|---|---|---|
| Example 1 | A-1 | B-1-1 | S-1 | — | None | — |
| Example 2 | A-1 | B-1-1 | S-1 | — | #3000-2 | — |
| Example 3 | A-1 | B-1-2 | S-1 | — | #3000-2 | — |
| Example 4 | A-1 | B-1-3 | S-1 | — | #3000-2 | — |
| Example 5 | A-1 | B-1-4 | S-1 | — | #3000-2 | — |
| Example 6 | A-2 | B-1-1 | S-1 | — | #3000-2 | — |
| Example 7 | A-3 | B-1-1 | S-1 | — | #3000-2 | — |
| Example 8 | A-4 | B-1-1 | S-1 | — | #3000-2 | — |
| Example 9 | A-1 | B-1-1 | S-1 | — | Acylic resin 1 | — |
| Example 10 | A-1 | B-1-1 | S-1 | — | Acylic resin 2 | — |
| Example 11 | A-1 | B-1-1 | S-1 | — | Polyurethane resin | — |
| Example 12 | A-1 | B-2-1 | S-1 | DBU | #3000-2 | — |
| Example 13 | A-1 | B-2-2 | S-1 | DBU | #3000-2 | — |
| Example 14 | A-1 | B-2-3 | S-1 | DBU | #3000-2 | — |
| Example 15 | A-1 | B-2-4 | S-1 | DBU | #3000-2 | — |
| Example 16 | A-1 | B-2-1 | S-1 | 2-ethyl-4-methylimidazole | #3000-2 | — |
| Example 17 | A-1 | B-2-1 | S-1 | N,N-dimethyldodecylamine | #3000-2 | — |
| Example 18 | A-1 | B-2-1 | S-1 | tetrabutylphosphonium bromide | #3000-2 | — |
| Example 19 | A-1 | B-3-1 | S-1 | 2,4,6-tris(dimethylaminomethyl) | #3000-2 | — |
| | | | | phenol | | |
| Example 20 | A-1 | B-3-2 | S-1 | N,N-dimethyldodecylamine | #3000-2 | — |
| Example 21 | A-1 | B-4-1 | S-1 | tetraethylammonium bromide | #3000-2 | — |
| Example 22 | A-1 | B-4-2 | S-1 | p-toluenesulfonic acid | #3000-2 | — |
| Example 23 | A-1 | B-5-1 | S-1 | triphenylphosphine | #3000-2 | — |
| Example 24 | A-1 | Novolac | S-1 | triphenylphosphine | #3000-2 | — |
| | | resin | | | | |
| Example 25 | A-1 | B-6-1 | S-1 | t-BuONa | #3000-2 | — |
| Example 26 | A-1 | B-6-2 | S-1 | EtOK | #3000-2 | — |
| Example 27 | A-1 | B-1-1 | S-1 | Acetic acid | #3000-2 | — |
| Example 28 | A-1 | B-1-1 | S-1 | dodecanethiol | #3000-2 | — |
| Example 29 | A-1 | B-1-1 | S-1 | metha-cresol | #3000-2 | — |
| Example 30 | A-1 | B-1-1 | S-1 | diethylene glycol | #3000-2 | — |
| Example 31 | A-1 | B-1-1 | S-1 | glycerol | #3000-2 | — |
| Example 32 | A-1 | B-1-1 | S-1 | — | #3000-2 | ATC-30 |
| Example 33 | A-1 | B-1-1 | S-2 | — | #3000-2 | ATC-30 |
| Example 34 | A-1 | B-1-1 | S-3 | — | #3000-2 | ATC-30 |
| Example 35 | A-1 | B-1-1 | S-4 | — | #3000-2 | ATC-30 |
| Comp. Ex. 1 | A-1 | B-1-1 | None | — | None | — |
| Comp. Ex. 2 | A-1 | B-1-1 | None | — | #3000-2 | — |
| Comp. Ex. 3 | None | None | S-1 | DBU | None | — |
| Comp. Ex. 4 | None | None | S-1 | DBU | #3000-2 | — |
| Comp. Ex. 5 | A-1 | None | S-1 | DBU | None | — |
| Comp. Ex. 6 | A-1 | None | S-1 | 2-ethyl-4-methylimidazole | #3000-2 | — |
| Comp. Ex. 7 | AC-1 | B-1-1 | S-1 | — | None | — |
| Comp. Ex. 8 | AC-2 | B-1-1 | S-1 | — | None | — |
| Comp. Ex. 9 | AC-3 | B-1-1 | S-1 | — | None | — |
| Comp. Ex. 10 | A-1 | BC-1 | S-1 | — | None | — |
| Comp. Ex. 11 | A-1 | BC-2 | S-1 | N,N-dimethyldodecylamine | None | — |
| Comp. Ex. 12 | A-1 | BC-3 | S-1 | tetraethylammonium bromide | None | ATC-30 |
| Comp. Ex. 13 | A-1 | BC-4 | S-1 | triphenylphosphine | None | ATC-30 |
| Comp. Ex. 14 | A-1 | BC-5 | S-1 | t-BuONa | None | ATC-30 |

ATC-30: aluminum tris(ethylacetoacetate)

TABLE 2

| | | | | Elastisity | | | Depth of | Depth of |
|---|---|---|---|---|---|---|---|---|
| | | Aqueous ink resistance | | (Plastic | Printing | Ink | engraving | engraving |
| | Rinsing | Residual | Swelling | deformation | durability | transfer | (μm) | (μm) |
| | properties | film ratio (%) | ratio (%) | ratio) | (m) | properties | (FC-LD) | (CO₂ laser) |
| Example 1 | B | 95 | 105 | 10 | 1,200 | A | 390 | 310 |
| Example 2 | A | 98 | 104 | 7 | 1,800 | A | 420 | 340 |
| Example 3 | A | 98 | 104 | 8 | 1,700 | A | 410 | 330 |
| Example 4 | A | 100 | 100 | 5 | 2,000 | AB | 420 | 330 |
| Example 5 | A | 100 | 100 | 5 | 2,050 | AB | 420 | 325 |
| Example 6 | A | 100 | 100 | 5 | 2,050 | AB | 410 | 340 |
| Example 7 | A | 99 | 103 | 7 | 1,600 | A | 410 | 340 |
| Example 8 | A | 100 | 103 | 7 | 1,500 | A | 410 | 340 |
| Example 9 | B | 99 | 101 | 8 | 1,600 | A | 390 | 290 |
| Example 10 | C | 96 | 104 | 10 | 1,350 | A | 380 | 304 |
| Example 11 | C | 95 | 105 | 9 | 1,500 | A | 370 | 300 |
| Example 12 | A | 97 | 103 | 6 | 1,900 | A | 400 | 310 |
| Example 13 | A | 98 | 104 | 6 | 1,950 | A | 405 | 315 |
| Example 14 | A | 99 | 101 | 5 | 2,050 | AB | 410 | 320 |
| Example 15 | A | 99 | 101 | 5 | 2,000 | AB | 422 | 338 |
| Example 16 | A | 97 | 103 | 6 | 1,950 | A | 420 | 333 |
| Example 17 | A | 95 | 105 | 6 | 1,900 | A | 425 | 340 |
| Example 18 | A | 97 | 102 | 6 | 1,950 | A | 425 | 330 |
| Example 19 | A | 95 | 105 | 8 | 1,700 | A | 430 | 340 |
| Example 20 | A | 99 | 101 | 8 | 1,750 | A | 430 | 340 |
| Example 21 | B | 98 | 104 | 8 | 1,600 | A | 390 | 305 |
| Example 22 | B | 97 | 105 | 8 | 1,650 | A | 398 | 310 |
| Example 23 | B | 96 | 105 | 7 | 1,800 | AB | 380 | 310 |
| Example 24 | B | 98 | 103 | 7 | 1,850 | AB | 380 | 305 |
| Example 25 | B | 94 | 108 | 10 | 1,250 | A | 365 | 309 |
| Example 26 | B | 93 | 108 | 10 | 1,300 | A | 360 | 300 |
| Example 27 | A | 98 | 104 | 6 | 1,950 | A | 420 | 340 |
| Example 28 | A | 98 | 104 | 6 | 1,950 | A | 425 | 345 |
| Example 29 | A | 98 | 104 | 6 | 1,950 | A | 410 | 330 |
| Example 30 | A | 91 | 111 | 6 | 1,900 | A | 400 | 330 |
| Example 31 | A | 92 | 110 | 6 | 1,900 | A | 390 | 300 |
| Example 32 | A | 100 | 101 | 6 | 1,950 | A | 440 | 360 |
| Example 33 | B | 98 | 102 | 8 | 1,650 | A | 445 | 365 |
| Example 34 | A | 100 | 100 | 6 | 1,900 | A | 430 | 350 |
| Example 35 | A | 100 | 100 | 6 | 1,900 | A | 440 | 350 |
| Comp. Ex. 1 | D | 80 | 125 | 38 | 300 | BC | 340 | 280 |
| Comp. Ex. 2 | D | 85 | 118 | 30 | 600 | C | 350 | 290 |
| Comp. Ex. 3 | D | 90 | 110 | 37 | 300 | BC | 345 | 280 |
| Comp. Ex. 4 | C | 95 | 106 | 35 | 400 | C | 330 | 260 |
| Comp. Ex. 5 | D | 90 | 110 | 32 | 500 | BC | 350 | 290 |
| Comp. Ex. 6 | C | 91 | 109 | 30 | 600 | C | 350 | 290 |
| Comp. Ex. 7 | D | 84 | 116 | 38 | 500 | BC | 390 | 310 |
| Comp. Ex. 8 | D | 85 | 115 | 37 | 300 | BC | 345 | 280 |
| Comp. Ex. 9 | D | 90 | 110 | 38 | 300 | BC | 330 | 260 |
| Comp. Ex. 10 | D | 80 | 120 | 37 | 300 | BC | 350 | 290 |
| Comp. Ex. 11 | D | 81 | 121 | 37 | 200 | BC | 340 | 290 |
| Comp. Ex. 12 | D | 80 | 120 | 39 | 300 | BC | 330 | 295 |
| Comp. Ex. 13 | D | 77 | 125 | 40 | 200 | BC | 334 | 301 |
| Comp. Ex. 14 | D | 75 | 135 | 42 | 200 | BC | 330 | 307 |

A-1 to A-4, B-1-1 to B-6-2, and S-1 to S-4 in Table 1 used in respective Examples and Comparative Examples are the same compounds as those described above.

The novolac resin used in Example 24 is a novolac resin (Mw=20,000) obtained from octylphenol and formaldehyde (50/50 mol %).

AC-1 to AC-3, and BC-1 to BC-5 in Table 1 is compounds shown below.

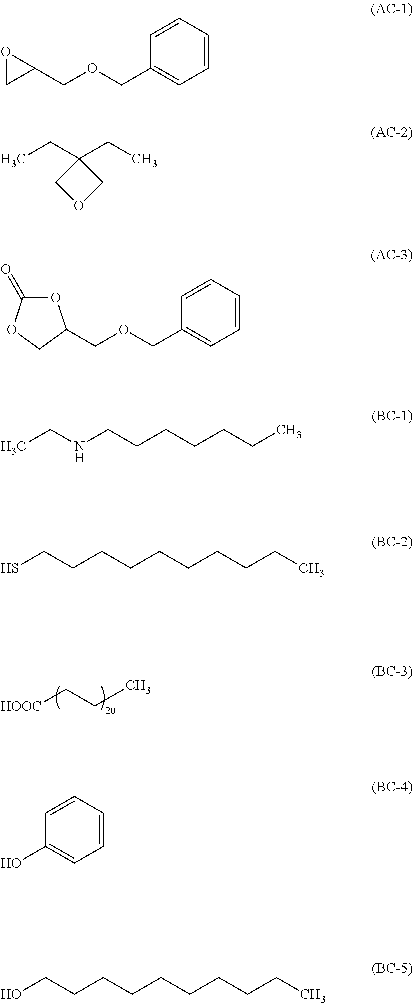

The following shows the details of a binder polymer (Component E) in Table 1 used in respective Examples and Comparative Examples.

#3000-2: Denka Butyral #3000-2 (Denki Kagaku Kogyo K.K., polyvinyl butyral derivative, Mw=90,000)

Acrylic resin 1: cyclohexyl methacrylate/2-hydroxyethyl methacrylate, copolymerization ratio: 70/30 (mol %), Mw=50,000)

Acrylic resin 2: cyclohexyl methacrylate/methyl methacrylate, copolymerization ratio: 70/30 (mol %), Mw=60,000)

Polyurethane resin: tolylene diisocyanate/polypropylene glycol (average molecular weight: 2,000), polycondensation ratio: 50/50 (mol %), Mw=90,000)

The following shows Component D and Component G listed in Table 1. “1,8-diazabicyclo[5.4.0]-7-undecene (DBU) (Wako Pure Chemical Industries, Ltd.),” “2-ethyl-4-methylimidazole (Tokyo Chemical Industry),” “N,N-dimethyldodecylamine (Tokyo Chemical Industry),” “tetrabutylphosphonium bromide (Tokyo Chemical Industry),” “2,4,6-tris(dimethylaminomethyl)phenol (Tokyo Chemical Industry),” “tetraethylammonium bromide (Tokyo Chemical Industry),” “p-toluenesulfonic acid (Wako Pure Chemical Industries, Ltd.),” “triphenylphosphine (Tokyo Chemical Industry,” “sodium tert-butoxide (t-BuONa) (Tokyo Chemical Industry,” “boron trifluoride/ethyl ether complex (BF₃OEt₂) (Tokyo Chemical Industry,” “acetic acid (Wako Pure Chemical Industries, Ltd.),” “thiophenol (Tokyo Chemical Industry),” “meta-cresol (Tokyo Chemical Industry),” “diethylene glycol (Tokyo Chemical Industry),” “glycerol (Tokyo Chemical Industry),” “tris(ethylacetoacetate) aluminum (Kawaken Fine Chemicals Co., Ltd.)”

What is claimed is:

1. A resin composition for laser engraving, comprising:
(Component A) a compound having two or more ring structures selected from the group consisting of an epoxy ring, an oxetane ring and a five-membered carbonate ring,
(Component B) a curing agent capable of reacting with Component A to thus form a crosslinked structure, and
(Component C) a compound having at least one of a hydrolyzable silyl group and a silanol group.

2. The resin composition for laser engraving according to claim 1, wherein Component B is a compound having one or more functional groups selected from the group consisting of a primary amino group and an acid anhydride group, or a compound having two or more functional groups selected from the group consisting of a secondary amino group, a mercapto group, a carboxyl group, a phenolic hydroxyl group and a hydroxyl group.

3. The resin composition for laser engraving according to claim 1, wherein Component C is a compound having a total of two or more hydrolyzable silyl groups and silanol groups.

4. The resin composition for laser engraving according claim 1, wherein the hydrolyzable silyl group in Component C is a hydrolyzable silyl group having at least one of an alkoxy group and a halogen atom bonded to a Si atom.

5. The resin composition for laser engraving according to claim 1, wherein Component A is a compound having two or more epoxy rings.

6. The resin composition for laser engraving according to claim 1, wherein the composition further comprises (Component D) a curing accelerator.

7. The resin composition for laser engraving according to claim 1, wherein the composition further comprises (Component E) a binder polymer.

8. The resin composition for laser engraving according to claim 7, wherein the glass transition temperature (Tg) of Component E is at least 20° C. but less than 200° C.

9. The resin composition for laser engraving according to claim 7, wherein Component E is one or more resins selected from the group consisting of an acrylic resin, polyvinyl butyral and derivatives thereof.

10. The resin composition for laser engraving according to claim 1, wherein the composition further comprises (Component F) a photothermal conversion agent capable of absorbing light having a wavelength of 700 to 1,300 nm.

11. The resin composition for laser engraving according to claim 1, wherein the composition further comprises (Component G) a catalyst for an alcohol exchange reaction.

12. A relief printing plate precursor for laser engraving, comprising a relief-forming layer comprising the resin composition for laser engraving according to claim 1 over a support.

13. A relief printing plate precursor for laser engraving, comprising a crosslinked relief-forming layer formed by crosslinking the relief-forming layer comprising the resin composition for laser engraving according to claim 1 by light and/or heat over a support.

14. The relief printing plate precursor for laser engraving according to claim 13, wherein the crosslinked relief-forming layer is a crosslinked relief-forming layer crosslinked by heat.

15. A process for producing a relief printing plate precursor for laser engraving, comprising:
a layer forming step of a relief-forming layer comprising the resin composition for laser engraving according to claim 1, and
a crosslinking step of crosslinking the relief-forming layer by light and/or heat to thus obtain a relief printing plate precursor having a crosslinked relief-forming layer.

16. The process for producing the relief printing plate precursor for laser engraving according to claim 15, wherein the crosslinking step is a step of crosslinking the relief-forming layer by heat to thus obtain a relief printing plate precursor having a crosslinked relief-forming layer.

17. A process for making a relief printing plate, comprising:
a layer forming step of a relief-forming layer comprising the resin composition for laser engraving according to claim 1,
a crosslinking step of crosslinking the relief-forming layer by light and/or heat to thus obtain a relief printing plate precursor having a crosslinked relief-forming layer, and
an engraving step of laser engraving the relief printing plate precursor having the crosslinked relief-forming layer to thus form a relief layer.

18. The process for making the relief printing plate according to claim 17, wherein the crosslinking step is a step for crosslinking the relief-forming layer by heat to thus obtain a relief printing plate precursor having a crosslinked relief-forming layer.

19. A relief printing plate having a relief layer manufactured by the process for making a printing plate according to claim 17.

20. The relief printing plate according to claim 19, wherein the thickness of the relief layer is at least 0.05 mm but no greater than 10 mm.

21. The relief printing plate according to claim 19, wherein the Shore A hardness of the relief layer is at least 50° but no greater than 90°.
